(19) United States
(12) Patent Application Publication
(10) Pub. No.: US 2013/0229298 A1
(43) Pub. Date: Sep. 5, 2013

(54) Threaded Track Method, System, and Computer Program Product

(71) Applicants: Adric Carlyle ECKSTEIN, Sterling, VA (US); Christopher Edward KURCZ, Rockville, MD (US); Marcio Oliveira SILVA, Fairfax, VA (US); William J. WEILAND, Reston, VA (US)

(72) Inventors: Adric Carlyle ECKSTEIN, Sterling, VA (US); Christopher Edward KURCZ, Rockville, MD (US); Marcio Oliveira SILVA, Fairfax, VA (US); William J. WEILAND, Reston, VA (US)

(73) Assignee: The MITRE Corporation, McLean, VA (US)

(21) Appl. No.: 13/411,138

(22) Filed: Mar. 2, 2012

(51) Int. Cl. G01S 13/58

(52) U.S. Cl. 342/107

(57) ABSTRACT

A system, method, and computer program product for determining a trajectory of an item includes segmenting surveillance point data of sensors, by sensor, into track segments for the item, associating the track segments for the item in a segment group for the item, and fusing the track segments in the segment group for the item into a synthetic threaded track for the item. The fusing may include filtering of the track segments for the item across track segments. The filtering across track segments may be based on a weighting of the point track data of the track segments for the item. A system for determining a trajectory of an item may include a processing device configured to execute a threaded track process to convert a data set of surveillance point data into a synthetic threaded track for the item.

### BACKGROUND OF THE INVENTION

1. Field of the Invention

The present invention generally relates to systems and methods for determining a trajectory of an item using surveillance point data associated with plural sensors for tracking the item.

2. Background

Known trajectory and tracking systems, methods, and data sets include the Semi-Automatic Ground Environment (SAGE) air defense system, the Enhanced Transportation Management System (ETMS), the Airport Surface Detection System Model X (ASDE-X), the En Route Automation Modernization (ERAM) program, the Automated Radar Terminal System (ARTS), the Standard Terminal Arrival Route (STAR) system, and the Surveillance Broadcast Service (SBS) system.

The SAGE system is an air defense network system that utilizes flight plans matched to radar returns, continuously and automatically, to aid in identifying aircraft.

The Federal Aviation Administration (FAA) uses the ETMS system at the Air Traffic Control System Command Center (ATCSCC), the Air Route Traffic Control Centers (ARTCCs), and major Terminal Radar Approach Control (TRACON) facilities to manage the flow of air traffic within the National Airspace System (NAS) in real time. Other organizations (e.g., commercial airlines, Department of Defense, NASA, and international sites) also have access to the ETMS software and/or data. Traffic management personnel use the ETMS system to predict, on national and local scales, traffic surges, gaps, and volume based on current and anticipated airborne aircraft. They use this information to evaluate the projected flow of traffic into airports and sectors, and to implement any appropriate restrictive action necessary to ensure that traffic demand does not exceed system capacity.

The ETMS system generates data used in the Aircraft Situation Display to Industry (ASDI) system. The ETMS/ASDI data stream consists of data elements that show the position and flight plans of all aircraft in a covered airspace. ETMS/ASDI data elements include the location, altitude, airspeed, destination, estimated time of arrival, and tail number or designated identifier of air carrier and general aviation aircraft operating on IFR flight plans within U.S. airspace.

ASDE-X is a surveillance system using radar and satellite technology that allows air traffic controllers to track surface movement of aircraft and vehicles in real time. ASDE-X enables air traffic controllers to detect potential runway conflicts by providing detailed coverage of movement on runways and taxiways. ASDE-X tracks vehicles and aircraft on the airport movement area and obtains identification information from aircraft transponders by collecting data from a variety of sources.

The data used by the ASDE-X comes from surface surveillance radar located on the air traffic control tower or remote tower(s), multilateration sensors, Automatic Dependent Surveillance-Broadcast (ADS-B) sensors, the terminal automation system, and from aircraft transponders. The ASDE-X system fases the data from these sources in real time to determine the position and identification of aircraft and transponder-equipped vehicles on the airport movement area, as well as of aircraft flying within five miles of the airport. Controllers in the tower see this information presented as a color display of aircraft and vehicle positions overlaid on a map of the airport's runways/taxiways and approach corridors. The system essentially creates a continuously updated map of the airport movement area that controllers can use to spot potential collisions.

Military applications for tracking aircraft, missiles, submarines, and the like in real time also are known.

Each of these systems provides continuously updated surveillance data in real time for tracking of aircraft in the air, sea, and/or on the ground. In each case, the data comes from related sources having a predefined association and/or registration.

### SUMMARY

A system and method for determining a trajectory of an item includes segmenting surveillance point data of plural sensors, by sensor, into track segments for the item, wherein each track segment for the item includes time serial surveillance point data for the item that is associated with a single sensor, associating the track segments for the item in a segment group for the item, and fusing the track segments for the item into a synthetic threaded track for the item.

In another aspect, the system and method utilize post-acquisition analysis of surveillance point data. The surveillance point data may be a data set presented as a data stream or data feed, or provided in a data store. The surveillance point data may be from unrelated sources, e.g., from sensors that are not in registration and/or not in sync.

In another aspect, the segmenting may include parsing the surveillance point data for point track data and point metadata. Parsing the surveillance point data may separate each surveillance point into its trajectory components (e.g., point track data) and identifying components or metadata (e.g., point flight metadata, such as aircraft ID and beacon code).

In another aspect, the segmenting may include validating the surveillance point data. Validating the surveillance point data may include detecting undesired data, such as corrupted data, coasted data, and outlier track point data, and further may include discarding the undesired data.

In another aspect, the validating may include detecting an undesired segment, and further may include discarding the undesired segment.

In another aspect, the validating may include correcting a sensor-based bias of point track data of the track segments. Correcting the sensor-based bias may be performed using a predetermined bias of the sensor.

In another aspect, the validating may include assigning track point weights for point track data of the track segments. Assigning track point weights for the point track data of the track segments may include applying a sensor accuracy model for the sensor generating the point track data. The sensor accuracy model may be predetermined based on the sensor type. The sensor accuracy model may include elements related to a local variance in the data or quantity of outliers.

In another aspect, associating the track segments into a segment group may include associating track segments for an item into a network of track segments for the item. Associating the track segments into a segment group may include metadata association (e.g., associating track segment pairs for an item based on matching of metadata for the track segments) and/or trajectory association (e.g., associating track segment pairs for the item based on a matching of trajectory information of the track segments). Trajectory association may include interpolating between track segment pairs that are overlapping, and/or extrapolating between track segments pairs that are not overlapping but have end points that are close in time and space. Associating track segments into a segment group may include determining a correlation characteristic between a pair of track segments based on metadata association or trajectory association, and creating a network of track segments based on the correlation characteristics of the track segments in a segment group.

In another aspect, associating the track segments into a segment group may include detecting an undesired track segment, such as a track segment that includes less than a threshold number of track data points, or a track segment that has excessive deviation compared with other track segments within the track segment group, and further may include discarding the undesired track segment.

In another aspect, fusing the track segments includes estimating and removing noise across track segments of a segment group for the item. The estimating and removing of noise across track segments may include filtering across track segments of a segment group for an item. The filtering across track segments may include at least one of cross track filtering, along track filtering, and vertical track filtering across track segments of a segment group for the item. The filtering across track segments may be performed as a parameterized or non-parameterized function.

In another aspect, the filtering across track segments may include performing an averaging function to windowed sensor points of a tracked item. The averaging function may be iteratively performed for windowed sensor points over a report of sensor state measurements for a sensor. The averaging function may include determining a weighted least squares of weighted windowed sensor points. The averaging function may include multi-model filtering of the weighted windowed sensor points.

In another aspect, the multi-model filtering may include applying the weighted least squares of the weighted windowed sensor points to a predetermined trajectory model(s). In a cross track filtering process, the multi-model filtering may include applying the weighted windowed sensor points to at least one trajectory model(s) selected from a straight trajectory model, a constant curvature (turning) trajectory model, a variable curvature (turning) trajectory model, and other higher order curvature (tuning) trajectory models. In an along track filtering process, the multi-model filtering may include applying the weighted windowed sensor points to at least one trajectory model(s) selected from a constant velocity trajectory model, a constant acceleration trajectory model, a variable acceleration trajectory model, and other higher order velocity/acceleration trajectory models. In a vertical track filtering process, the multi-model filtering may include applying at least one trajectory model(s) selected from a linear climb gradient trajectory model, a linear climb rate trajectory model, and other higher order ascent/descent trajectory models.

### BRIEF DESCRIPTION OF THE DRAWINGS

The accompanying drawings, which are incorporated herein and form a part of the specification, illustrate the present invention and, together with the written description, further serve to explain principles of the invention and to enable a person skilled in the pertinent art to make and use the invention.

FIG. 1 is a flow diagram schematically illustrating an embodiment of a threaded track process of the present application.

FIG. 2 is a graph schematically illustrating in vertical profile an exemplary mosaic flight radar system for determining a synthetic trajectory or threaded track according to the present application.

FIG. 3 is a graph illustrating in horizontal profile exemplary raw surveillance data input and a resultant synthetic trajectory or threaded track for a portion of an aircraft flight.

FIG. 4 is a flow diagram schematically illustrating another embodiment of a threaded track process of the present application.

FIG. 5 is a flow diagram schematically illustrating another embodiment of a threaded track process of the present application.

FIG. 6, including FIGS. 6A and 6B, illustrates a plurality of aircraft tracking sensors of an exemplary aircraft surveillance/tracking system that may be used to generate surveillance point data suitable for a threaded track process of the present application.

FIG. 7, including FIGS. 7A, 7B, and 7C, is a flow diagram schematically illustrating an exemplary embodiment of a track segmentation by sensor routine that may be used in a threaded track process of the present application.

FIG. 8 is a flow diagram schematically illustrating an exemplary segment associating routine that may be used in a threaded track process of the present application.

FIG. 9 is a flow diagram schematically illustrating an exemplary data filtering routine that may be used in a threaded track process of the present application.

FIG. 10 is a schematic drawing of an exemplary computer system suitable for implementing a threaded track process of the present application.

The present invention will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION OF EMBODIMENTS

### Overview of Threaded Track Process

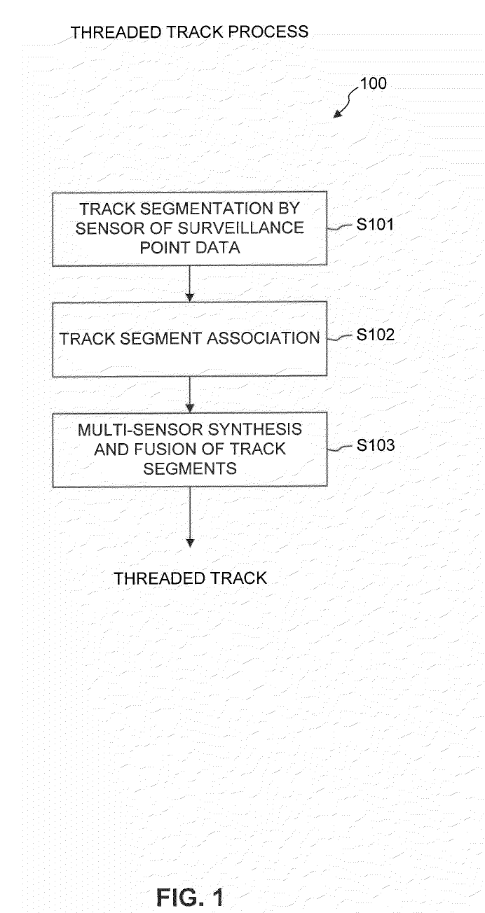

FIG. 1 is a flow diagram schematically illustrating an exemplary embodiment of a threaded track process of the present application. The threaded track process 100 generally includes: S101 Track Segmentation By Sensor Of Surveillance Point Data, S102 Track Segment Association, and S103 Multi-Sensor Synthesis And Fusion Of Track Segments to create a synthetic Threaded Track. More specifically, at S101 the threaded track process includes segmenting surveillance point data of multiple sensors (or sources of surveillance point data), by sensor, into track segments for a tracked item, wherein each track segment for the tracked item includes time serial surveillance point data for the item that is associated with a single sensor. At S102 the threaded track process includes associating track segments for a single item across all sensors to form a segment group for the item. At S103 the threaded track process includes fusing the track segments in the segment group for the item into a synthetic threaded track for the item. As discussed further herein, it will be appreciated that the segmenting process at S101 may be performed independently of the associating track segments process and fusing of track segments process at S102 and S103 (illustrated as a dashed line). For example, surveillance point data for plural sensors may be segmented by sensor and stored as a data set in a data store for further processing at a later time. The data set of segmented surveillance point data may then be further processed a later time into a synthetic threaded track.

As disclosed herein, a threaded track process of the present application fuses together track segments of surveillance point data for a range of arbitrary sensors or sources. Accordingly, a component of a threaded track process may include defining a registration between arbitrary (e.g., related and/or unrelated) sensors or sources in a system or network. For example, in an exemplary aircraft surveillance/tracking system this may be performed by correlating multiple radar facilities that are tracking multiple aircraft to measure radar registration as well as by defining relationships within flight metadata to associate flights with one another.

In the present application, a threaded track process is illustrated by exemplary embodiments using an aircraft surveillance/tracking system. However, the threaded track process is not limited to an aircraft surveillance/tracking system, and may be utilized with other surveillance/tracking systems or applications that are based on time serial surveillance point data. Other exemplary systems and applications include maritime surveillance/tracking applications, terrestrial surveillance/tracking applications, automobile surveillance/tracking applications, cellular radio network device surveillance/tracking applications, search and rescue applications, salvage applications (e.g., underwater), mapping applications, and the like. In an exemplary system, an automobile “black box” and the automobile driver's cellular phone could provide two unrelated sensors/sources of surveillance point data for determining a trajectory of the automobile and driver in an accident analysis. Those skilled in the art readily will appreciate other surveillance/tracking systems and applications for implementing a threaded track process of the present application.

Based on an exemplary aircraft surveillance/tracking system, a threaded track process of the present application can develop from raw aircraft surveillance point data of multiple related or unrelated surveillance sources (facilities/sensors) an end-to-end flight trajectory that integrates data from the multiple surveillance sources for a given aircraft. For example, the NAS currently includes approximately 35 ASDE-X airports and 147 NOP TRACONS that provide daily feeds for input of surveillance point data to a NAS-wide data feed. A threaded track process of the present application can process and convert surveillance point data from a data set including such sources of surveillance point data (e.g., ETMS data, ASDE-X data, etc.), into a synthetic threaded track for an aircraft/flight. As discussed below, those skilled in the art will appreciate that in different embodiments a threaded track process of the present application may operate on a static data set (e.g., a database in a data store), a periodically updated data set, or a dynamic data feed.

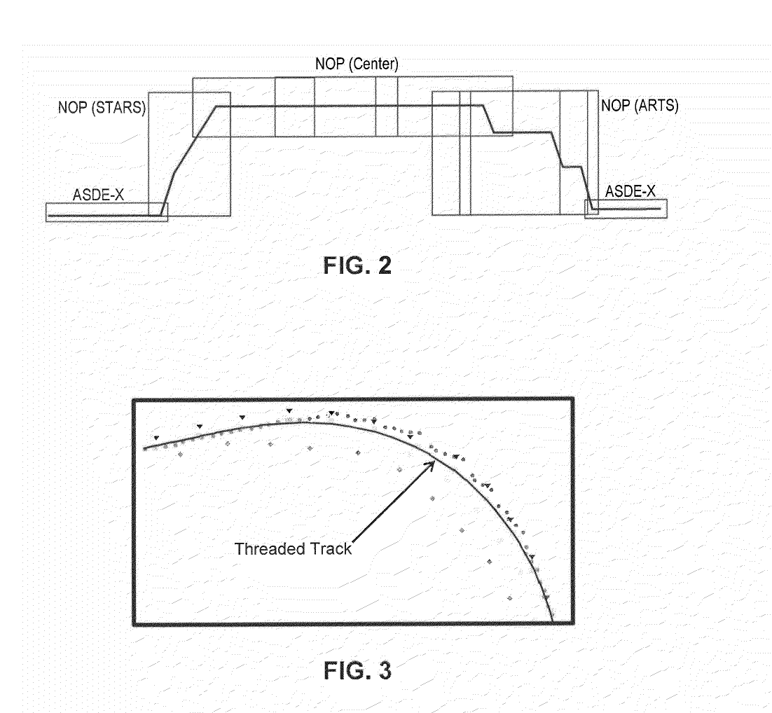

FIGS. 2 and 3 schematically illustrate an exemplary synthetic trajectory or threaded track according to a threaded track process of the present application. FIG. 2 is a graph that schematically illustrates in vertical profile an exemplary mosaic surveillance/tracking system for a synthetic trajectory or threaded track according to a threaded track process of the present application, and FIG. 3 is a graph that illustrates in horizontal profile raw surveillance point data input and a resultant synthetic trajectory or threaded track for a portion of an aircraft/flight trajectory. As shown FIG. 2, an exemplary mosaic surveillance/tracking system for tracking a single aircraft/flight may include overlapping ranges of various surveillance/tracking sources, e.g., including originating ASDE-X, NOP (STARS), NOP (Center), NOP (ARTS), and terminating ASDE-X surveillance/tracking facilities. In accordance with a threaded track process, raw surveillance point data from these sources is segmented, by sensor, into track segments for the aircraft/flight. In FIG. 3, time serial surveillance point data for multiple sources are respectively indicated by square-, triangle-, circle-, and diamond-shaped icons, and a synthetic threaded track for the tracked item is illustrated as a line. As shown in FIGS. 2 and 3, processing a NAS data set with a series of noise estimating and filtering algorithms of a threaded track process, including segmenting the surveillance point data by sensor into track segments for the aircraft/flight, associating the track segments for the aircraft/flight in a segment group, and fusing the track segments in the segment group into a synthetic trajectory, provides a single, high fidelity, synthetic trajectory data set. The synthetic threaded track data set has significantly improved accuracy over the raw surveillance point data input, which is limited by real-time acquisition. This single synthesized trajectory data provides a best estimate of the integrated trajectory of an aircraft/flight by segmenting the surveillance data into track segments by sensor, associating the track segments in a segment group, and applying to the track segments in the segment group a series of noise attenuation algorithms that are tuned to the accuracies of the various track input sources/sensors.

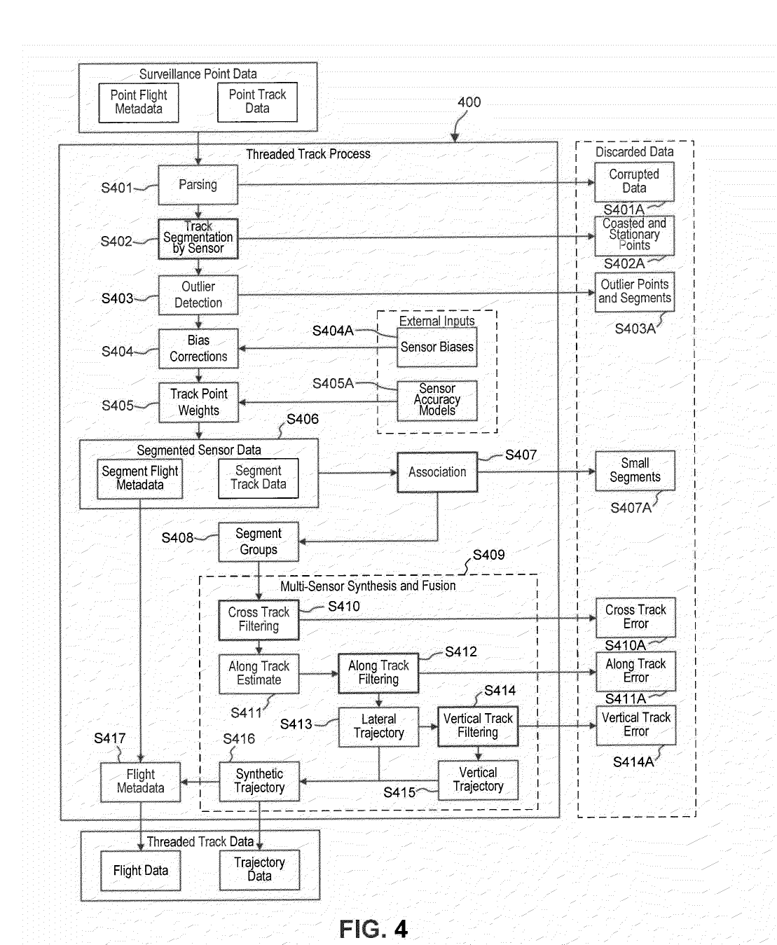

FIG. 4 is a flow diagram schematically illustrating another embodiment of a threaded track process 400 of the present application. As shown in FIG. 4, in this embodiment, like the embodiment of FIG. 1, threaded track process 400 generally includes Track Segmentation By Sensor of the surveillance point data (S402); Association of Track Segments in a Segment Group (S407, S408); and Multi-Sensor Synthesis and Fusion of the track segments (S409) to create a synthetic trajectory (Threaded Track Data). However, in this embodiment the treaded track process 400 variously and/or optionally may include processes of: S401 Parsing surveillance point data; S402 Track Segmentation By Sensor of the surveillance point data; S403 Outlier Detection, e.g., including detecting outlier points or segments; S404 Bias Correction, e.g., including applying an external Sensor Bias input S404A to correct track point data; S405 Track Point Weights, e.g., including applying an external Sensor Accuracy Model S405A to assign weights to the track point data; S407 Association of track segments (Segmented Sensor Data S406) into a Segment Group S408 for a tracked item; and S409 Multi-Sensor Synthesis and Fusion of the track segments in the segment group S408 to create a synthetic trajectory or Threaded Track (Threaded Track Data). As schematically illustrated in the exemplary embodiment of FIG. 4, the multi-sensor synthesis and fusion S409 may include processes of: S410 Cross Track Filtering across the track segments in a segment group to obtain an Along Track Estimate (S411); S412 Along Track Filtering of the along track estimate S411 to obtain a Lateral Trajectory S413; and S414 Vertical Track Filtering of the lateral trajectory S413 to obtain a Vertical Trajectory S415, wherein the multi-sensor synthesis and fusion process S409 combines the lateral trajectory S413 and the vertical trajectory S415 to obtain a Synthetic Trajectory S416, and the threaded track process 400 presents the synthetic trajectory S416 and associated Flight Metadata S417 obtained from the segmented flight metadata S406 as synthetic threaded track data.

As shown in FIG. 4, in this embodiment a threaded track process 400 may perform various and optional filtering processes that detect and discard data that is undesired or non-essential to the process. At S401 the parsing of surveillance point data may include detecting and/or discarding Corrupted Data S401A. At S402 the track segmenting by sensor of the surveillance point data may include detecting and/or discarding Coasted and Stationary Points S402A. At S403 the outlier detecting may include detecting and/or discarding Outlier Points and/or Segments S403A. At S407 the associating of track segments in a segment group may include detecting and/or discarding undesired track segments, e.g., a track segment that is smaller than a threshold size, or a track segment that has excessive deviation compared with other track segments within the track segment group. At S411 the cross track filtering of the track segments in a segment group may include discarding Cross Track Error data S411A. At S413 the along track filtering may include discarding Along Track Error data S413A. At S415 the vertical track filtering may include discarding Vertical Track Error data S451A. Those skilled in the art readily will appreciate various and alternative combinations of filtering processes for achieving a desired threaded track process and application.

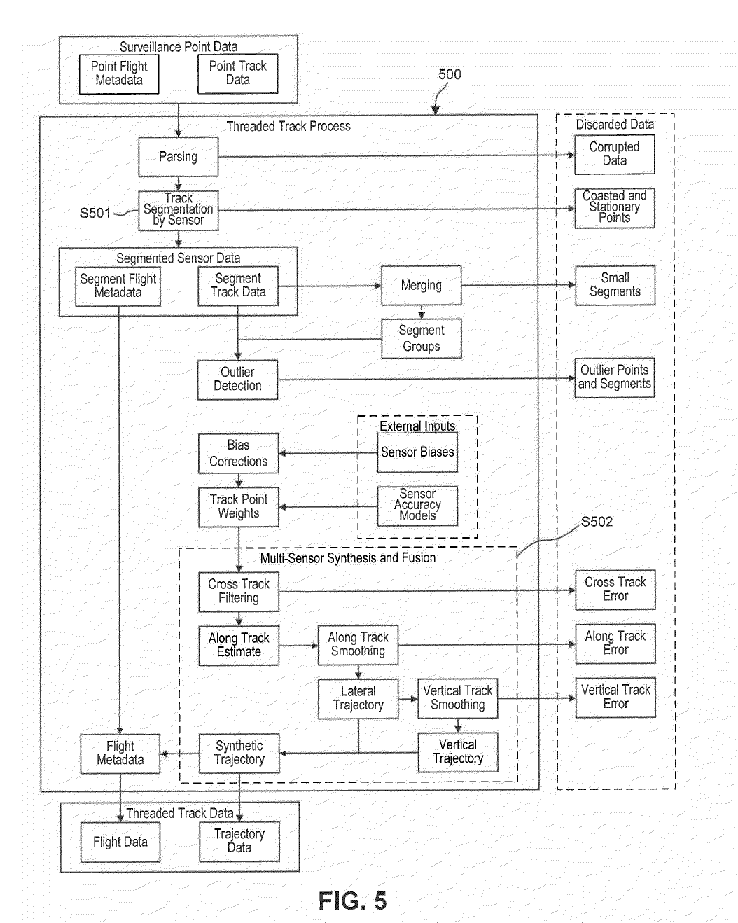

FIG. 5 is a flow diagram schematically illustrating another embodiment of a threaded track process of the present application. As shown in FIG. 5, in this embodiment, like the embodiment of FIGS. 1 and 4, a threaded track process 500 includes Track Segmentation by Sensor of the surveillance point data (S501), Association of track segments in a segment group (identified herein as “Merging S502”), and Multi-Sensor Synthesis and Fusion of the track segments (S503) to obtain a synthetic trajectory/Threaded Track Data. In this embodiment the threaded track process 500 variously and/or optionally includes other processes that are substantially the same or similar to processes of the embodiment illustrated in FIG. 4, wherein track segments are submitted to an associating (merging) process prior to outlier detection, bias correction, and track point weighting. Features, functions, and aspects of the various processes of a threaded track process as illustrated in FIG. 4 and FIG. 5 are further described below. Accordingly, for simplicity and to avoid confusion, FIG. 5 schematically illustrates various processes and data sets using same or similar name designators as FIG. 4, without reference numbers.

As further discussed below, FIGS. 4 and 5 schematically illustrate routines and/or processes that variously or optionally may be applied in a threaded track process of the present application. Also as illustrated, and as further discussed below, certain routines and/or processes may be performed in alternative order. Those skilled in the art readily will appreciate alternative embodiments of a threaded track process variously applying alternative desired combinations of the disclosed routines and processes.

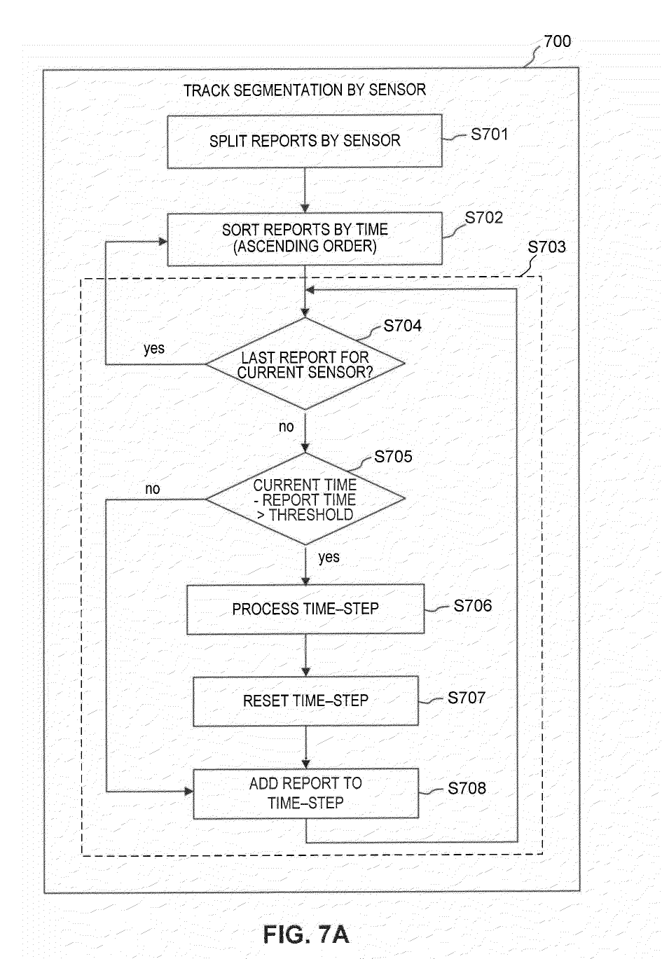

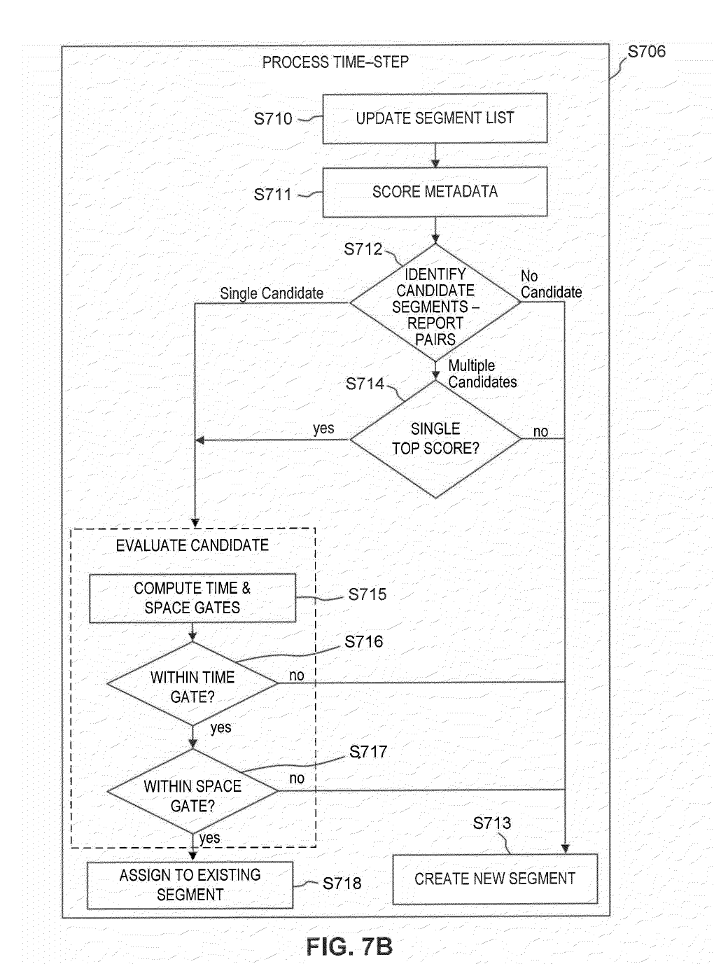

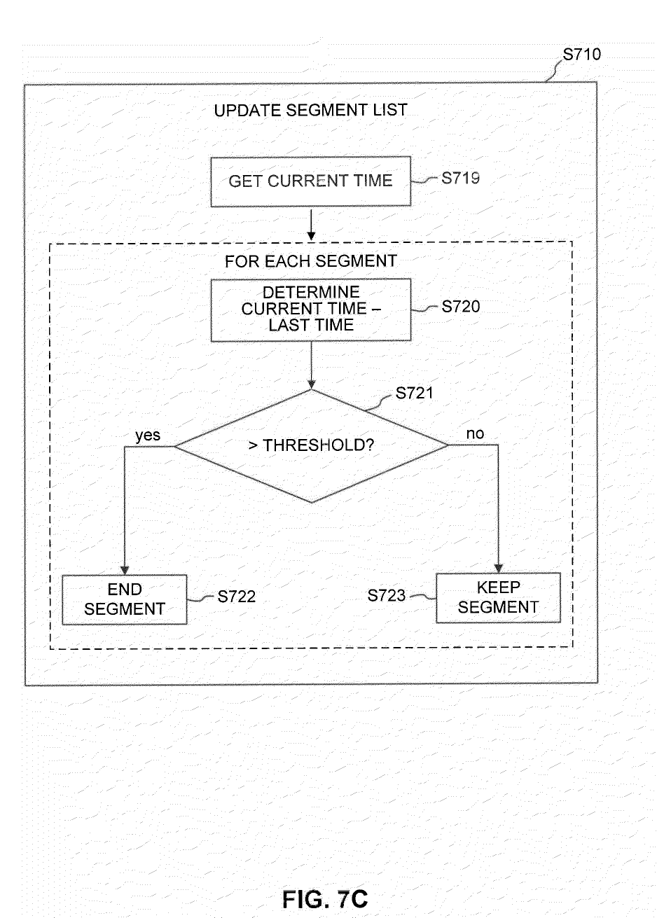

Various aspects, routines, and processes of exemplary embodiments of a threaded track process of the present application are described below with respect to FIGS. 1-10. Exemplary embodiments of processes for track segmentation by sensor, association of track segments in a segment group, and multi-sensor synthesis and fusion of track segments in the segment group (including exemplary filtering processes across track segments) are discussed with respect to FIGS. 7A-7C, 8, and 9 below.

Surveillance Point Data

A threaded track process generally operates on a set of surveillance point data from a plurality of sources. The plurality of sources may be of the same type or different types. The sources further may be related or unrelated, e.g., one or more of the sources may or may not be in registration or in sync with one or more other sources. In essence, a threaded track process operates on a set of post-acquisition surveillance point data. However, as discussed below, in an embodiment a threaded track process alternatively may operate as a near real-time trajectory determining process, e.g., on a dynamic data feed.

Surveillance point data generally may include any input data from a surveillance or tracking sensor or source of surveillance/tracking information, known now or in the future. Surveillance point data generally includes time sequential data points detected, generated, and/or reported by a sensor or other source of surveillance/tracking information. Surveillance point data generally may include point track data and associated point metadata. Point track data may be any space and time related data, e.g., two-dimensional or three-dimensional space data (e.g., Longitude/Latitude or Latitude/Longitude/Altitude) and associated time data. Point track data also may include further information associated with the space and time data (e.g., in an aircraft/flight application, the point track data may include further information such as heading and speed). Point metadata is any data that may be used to associate or identify point track data with a particular item being tracked, so that point track data of different tracking sources may be associated with a common tracked item. It will be appreciated that surveillance data associated with different sources/sensors for a tracked item may include varied constituent data, e.g., arranged by constituent data fields. For example, in an aircraft/flight application, point track data of different sources/sensors may include different point track data fields (e.g., selected ones of Latitude, Longitude, Altitude, Heading, Speed, and the like), and/or different metadata fields (e.g., selected ones of Flight #, Tail #, Departure location, Destination location, Beacon code, and the like). A threaded track process of the present application uses either or both point track data and associated point metadata to combine track segments of surveillance point data from multiple related or unrelated sources to produce a synthetic trajectory/threaded track data that has high fidelity.

In an exemplary embodiment, surveillance point data may include aircraft flight data. Exemplary aircraft flight surveillance/tracking sources include radar, global positioning satellite (GPS) sensors, DME system sources, on-board sensors such as altimeters, air speed sensors, accelerometers, gyroscopes, and the like. Exemplary aircraft surveillance point data includes flight trajectory point data and associated flight metadata. Exemplary flight trajectory point data includes latitude, longitude, altitude, heading, bearing, speed, acceleration, curvature, bank angle, and the like. Flight metadata may include any data used to associate trajectory point data with a particular aircraft. Exemplary flight metadata includes aircraft type, aircraft ID, beacon codes, tail number, departure location, departure time, arrival location, arrival time, flight plan information, and the like. Different sensors and sources for aircraft surveillance point data often generate or report different types of trajectory point data and/or metadata. Also, surveillance point data from one sensor or source may not be in registration or in sync with surveillance point data from one or more other sensor or source. Further, it will be appreciated that the number of surveillance data points and point data elements in either a real time data stream/feed or post-acquisition surveillance point data set may be in the billions. As discussed herein, a threaded track process of the present application uses various algorithms, such as track segmenting by sensor, associating track segments in segment groups, merging, matching, filtering, and smoothing algorithms, to transform a volume of surveillance data into a manageable size and format that accommodates these differences in data, registration, and sync. In view of the present disclosure, those skilled in the art readily will appreciate suitable surveillance sources and sensors, surveillance data, and threaded track algorithms for a desired surveillance and trajectory/threaded track determining application.

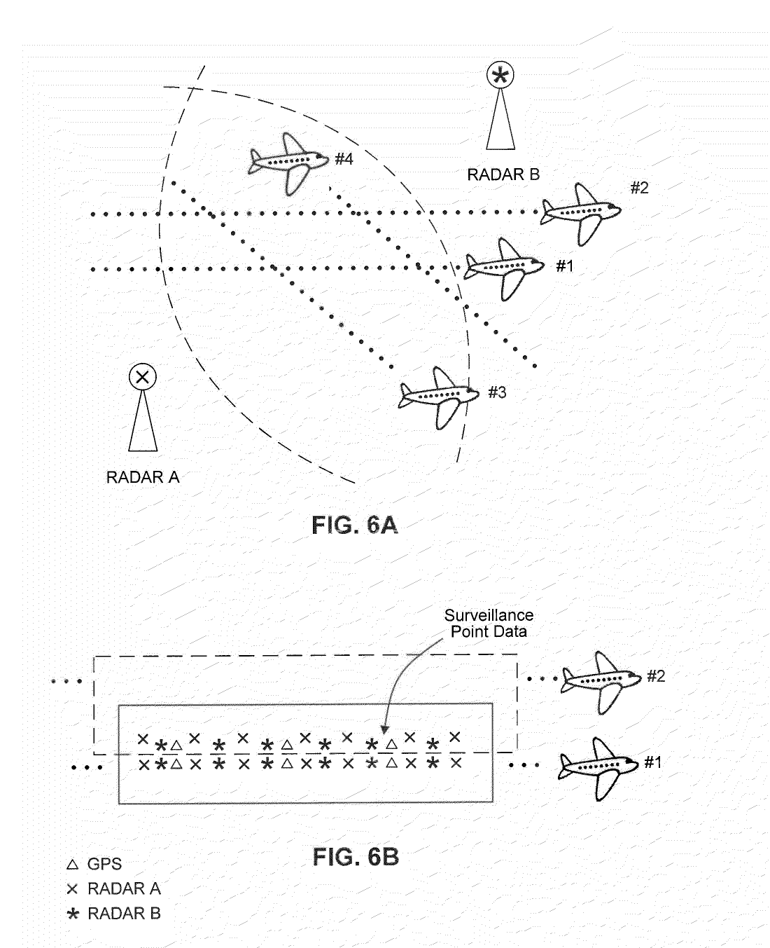

FIG. 6, including FIGS. 6A and 6B, illustrates a plurality of aircraft surveillance/tracking sources or sensors of an exemplary aircraft surveillance/tracking system or network that may be used to generate surveillance point data suitable for a threaded track process of the present application. As shown in FIG. 6A, the exemplary aircraft surveillance network includes surveillance sources at radar facilities A and B. Radar A and radar B may be of the same or different type. Each aircraft also may include an on-board GPS and/or DME surveillance source(s). Each GPS/DME surveillance source may be of the same or different type. Each of these surveillance sources may provide a separate source of surveillance point data that may be processed using a threaded track process of the present application. Each of these surveillance sources may or may not be in registration or in sync with each other surveillance source. FIG. 6B schematically illustrates an exemplary graphical display of surveillance point data for aircraft #1 and aircraft #2 of FIG. 6A, including time serial point track data for radar A and radar B for each of aircraft #1 and aircraft #2, GPS for aircraft #1, and GPS for aircraft #2. As shown, radar A, radar B, GPS #1, and GPS #2 may be unrelated, and the time serial track point data for radar A, radar B, GPS #1, and GPS #2 may be out of registration and/or out of sync with one another. These surveillance point sources and data types merely are exemplary. Those skilled in the art readily will appreciate additional and/or alternative sources of surveillance data and surveillance data types suitable for a desired threaded track application.

Parsing

Parsing is a filtering process that may be applied to surveillance point data in a threaded track process of the present application. As discussed below, parsing may be one of a series of filtering processes in a threaded track process. Generally, a parsing process identifies various trajectory point data and associated metadata from a surveillance data source, and organizes the data into a format suitable for further processing by a threaded track process. Parsing surveillance point data generally requires an understanding of how each type of surveillance point data is created, stored, and/or accessed, i.e., the data type(s) and format(s), for each source of surveillance data must be known and normalized in processing a synthetic trajectory/threaded track data. Accordingly, each time a new source of surveillance point data is introduced to a surveillance point data set for a threaded track system, a parsing process may require modifying in order to enable the threaded track process to access, parse, and/or store the surveillance point data in a format suitable for the threaded track process.

Parsing also may be used for detecting undesired data in the surveillance point data, such as corrupted data or non-essential data. As illustrated in FIGS. 4 and 5, a parsing process may include discarding the undesired data.

Parsing of the surveillance point data is an optional process of a threaded track process. For example, in an exemplary embodiment, all surveillance point data of plural surveillance sources may be pre-stored and/or presented in a common format, e.g., with common point track data and point metadata separated and arranged in a predetermined manner (format) suitable for processing in a desired threaded track process. However, because surveillance point data typically comes from multiple and different types of sources, surveillance point data typically will require parsing.

Track Segmentation by Sensor

A track segmentation by sensor process generally separates or segments surveillance point data for all sources of the data, by sensor, into track segments respectively associated with a single item or entity being tracked. A surveillance source may concurrently track multiple items, and a track segmentation by sensor process may create track segments for each tracked item. In this manner, track segments generated by a track segmentation by sensor process may be used to perform a threaded track process for one or more items on an item-by-item basis.

Based on a track segmentation by sensor process, each track segment is believed, with a desired level of confidence, to include only surveillance point data associated with a single item being tracked. In an exemplary aircraft tracking embodiment, e.g., as shown in FIGS. 6A and 6B, a single tracked item is a single aircraft/flight.

In a track segmentation by sensor process, surveillance point data associated with a single sensor for a tracked item may be separated into plural track segments for the item. In practice it often is. In an exemplary aircraft tracking system, an aircraft may fly over a radar installation or relative to another surveillance/tracking source in a manner that causes a break in detection or reporting by the radar or other surveillance/tracking source. For example, during a landing approach, an aircraft may fly in and out of range of a particular radar. Alternatively, a sensor may have an error or null reading that can result in a break in a track segment associated with the sensor. Those skilled in the art readily will appreciate various circumstances and situations that may cause separation or a break in a track segment(s) depending on the particular surveillance/tracking application and system.

Generally, a track segmentation by sensor process groups together individual time sequential surveillance data points that have a level of correspondence sufficient to say with a desired level of confidence that the time sequential surveillance data points are associated with a single aircraft/flight. The track segmentation by sensor process may vary depending on the source and type of raw data in the surveillance point data. In an exemplary aircraft surveillance/tracking system, the track segmentation by sensor process assures that no track point within a given track segment belongs to two different aircraft/flights. The track segmentation by sensor process further assures that each segment has a desired high level of confidence of association with a specific tracked item (e.g., a single aircraft/flight) so that multiple track segments for the single item trajectory can be fused later by operation of the threaded track process. An exemplary track segmentation by sensor routine is described below. Those skilled in the art readily will be able to identify alternative processes for grouping together individual time sequential data points for a tracked item suitable for a desired threaded track application.

Exemplary Track Segmenting by Sensor Routine

FIGS. 7A-7C illustrate an exemplary Track Segmentation By Sensor routine 700 that may be used in a threaded track process of the present application (see, e.g., FIG. 1, S101; FIG. 4, S402; or FIG. 5, S501). Track segmentation by sensor routine 700 generally is a process for grouping individual time-sequential surveillance data points (reports) that are associated with an individual sensor into one or more track segments that are associated with that individual sensor. As illustrated in FIG. 7A, exemplary track segmentation by sensor routine 700 may include an iterative process (indicated by interior dashed line S703) for identifying successive groups of associated surveillance data points from a single sensor that may be further processed together in a time-step process. FIG. 7B illustrates an exemplary “Process Time-Step” subroutine (S706) for assigning each individual surveillance data point (report) in an identified group of surveillance data points (reports) to a respective active track segment in a segment list. FIG. 7C illustrates an exemplary “Update Segment List” subroutine (S710) for updating the segment list of active track segments to which individual surveillance data points (reports) may be assigned in a process time-step subroutine S706 (FIG. 7B). The exemplary process of FIG. 7A-7C is discussed in more detail below.

FIG. 7A illustrates an overall track segmentation by sensor process 700, including an iterative process 5703 for identifying successive groups of associated surveillance data points (reports) from a single sensor for further processing in successive process time-steps.

At S701 the process initially splits (separates) surveillance point data reports for all sensors, by sensor. In an exemplary aircraft surveillance/tracking embodiment, surveillance point data reports may be from multiple radar installations along an aircraft's flight path, GPS location sensors, on-board sensors such as altimeters, air speed indicators, accelerometers, directional gyros, and the like, as discussed above. Surveillance point data reports are sensor specific. For example, a surveillance point data report for an onboard GPS sensor may include a single latitude/longitude/altitude/time data point for a single aircraft flight. A surveillance point data report for a radar may include a single surveillance data point for a single aircraft/flight reported by the radar during a reported sweep of the radar. Those skilled in the art readily will recognize various alternative surveillance point data reports and reporting formats associated with sensors for a desired threaded track system and application.

At S702, the process sorts the surveillance point data reports by time, in ascending order, for each sensor.

At S703 (indicated by an interior dashed line) the process operates on the surveillance point data reports in an iterative process, per sensor, by successively grouping surveillance data points (reports) with an associated “process time-step” for the sensor. Determining a process time-step for a sensor, and groupings of surveillance data points (reports) associated with the process time-step for the sensor, is sensor specific. For example, in an exemplary aircraft surveillance/tracking system, each sweep of a single radar has the same time period. And each sweep of the radar is expected to include a single surveillance data point for each aircraft/flight being tracked by the radar during that time period. Accordingly, the track segmentation by sensor process may define a single sweep of the radar as corresponding to a process time-step for the radar, and iterative process S703 may identify surveillance data points (reports) generated by the radar during a single radar sweep as being a group of associated surveillance data points for a process time step of the radar. In this case, the track segmentation by sensor process may be expected to assign (associate) no more than one surveillance data point (report) to any given track segment in the process time-step routine (FIG. 7B, S706). In an alternative embodiment, the track segmentation by sensor process may define a process time-step as corresponding to two sweeps of the radar. In this case, the track segmentation by sensor process may be expected to assign no more than two surveillance data points (reports) to any one segment in a process time-step routine (FIG. 7B, S706). A process time-step may be selected to provide a desired expected number of reports to be processed in the process time-step, e.g., a number suitable for a processing power or data storage characteristic of the system. Those skilled in the art will be able to identify alternative and respective process time-steps and groupings of associated surveillance point data reports suitable for various sensors of a desired surveillance/tracking system and threaded track application.

At S703 the process sequentially iterates over all surveillance point data reports for an individual sensor. This process may be performed for each sensor, by sensor. After the process is performed for all sensors, the track segmentation by sensor process is complete.

At S704, the process determines whether a current report is the last report for the current sensor. If “yes,” then the process returns to S702 to process surveillance data points for any additional individual sensor or source of surveillance point data (reports). If there are no additional sensors (no additional surveillance point data at S702), then the track segmentation by sensor process ends. If at S704 the process determines that the current report is not the last report for the current sensor (“no”), then the process continues to S705.

At S705, the process determines, for each surveillance data point (report), whether a value of a current time minus a report time is greater than a threshold value, where the “current time” corresponds to an initial time for a current process time-step. For example, as discussed above, in an exemplary aircraft surveillance/tracking system, the current time for a process time-step may be an initial time for a sweep of the radar, and the “report time” is the time of a subject surveillance data point (radar report). The threshold value is sensor specific. Generally, as discussed above, the threshold value is selected in accordance with a process time-step characteristic of the sensor, e.g., indicating that a subject surveillance data point (report) is associated with a current process time-step for the sensor.

If at S705 the process determines that the subtraction value is greater than the threshold value (“yes”), that is, the process determines that the subject surveillance point data report is not within the current process time-step of the sensor, then the process proceeds to S706. At S706, the process performs a “Process Time-Step” subroutine (see FIG. 7B) for all surveillance point data reports in the current process time-step. At S707 the process resets the time-step, and at S708 the process adds the subject surveillance point data report to the new current process time-step.

If at S705 the process determines that the subtraction value is not greater than the threshold value (“no”), that is, the process determines that the subject surveillance point data report is within the current process time step of the sensor, then the process proceeds to S708. At S708 the process adds the subject surveillance point data report to the current process time-step, and returns to the beginning of the iterative subroutine 5703 to process the next sequential surveillance point data report for the current sensor.

FIG. 7B illustrates an exemplary “Process Time-Step” subroutine S706 for assigning individual surveillance data points (reports) from an identified group of surveillance data points (reports) in a current process time-step to individual track segments. For example, in the exemplary aircraft surveillance/tracking system of FIG. 6, for each process time-step (e.g., for each sweep of radar B), individual surveillance data points (individual reports) for four aircraft/flights being tracked by radar B may be sequentially and respectively assigned to four active track segments in a segment list for sensor B. This exemplary process is further explained below.

At S710 the process time-step subroutine S706 initially performs an “Update Segment List” subroutine S710 (see FIG. 7C, discussed below). Generally, this process updates a list of active candidate track segments to which an identified group of surveillance track data points in the current process time-step may be assigned.

At S711 the process scores the metadata of each surveillance data point (report) in the identified group of surveillance data points (reports) by comparing the metadata of the surveillance data point (report) to the metadata of each active track segment in the updated/active segment list.

At S712 the process identifies candidate segment-report pairs. For example, in an exemplary embodiment, the process determines, for each comparison (for each candidate segment-report pair), whether the metadata score indicates that the metadata for the subject surveillance data point sufficiently matches the subject surveillance data point with (1) no candidate, (2) a single candidate, or (3) multiple candidates in the segment list.

If at S712 the process determines that the metadata of the subject surveillance data point does not match with the metadata of any active candidate segment in the segment list (“No Candidate”), then the process proceeds to S713, and the process creates a new track segment including the subject surveillance data point (report) and adds the new track segment to the segment list.

If at S712 the process determines that the metadata of the subject surveillance data point (report) possibly (e.g., partially) matches with multiple active candidate segments in the segment list (“Multiple Candidates”), then the process proceeds to S714.

At S714 the process separates unique segment-report pairs for evaluation and determines whether there is a single top score (i.e., a clear best metadata match) with one of the multiple candidate segments. In this regard, it will be appreciated that metadata for a tracked item may change over time. For example, in an exemplary aircraft surveillance/tracking system, metadata for each aircraft/flight may and often does change, e.g., the beacon code may change, a track ID may change, an operator may mis-key a tracking data entry during tracking handover, or a sensor may have an erroneous or null reading. Any of these or other changes can cause a disparity in metadata from one surveillance data point to a successive surveillance data point for a single sensor. Such a disparity may lower a matching score of the surveillance data point (report) with an active candidate track segment in the segment list. If the process determines that there is no single top score (“no” at S714), then the process proceeds to S713. At S713 the process creates a new track segment including the subject surveillance data point (report), and adds the new track segment to the segment list.

If at S712 the process determines that the metadata of the subject surveillance data point matches with a single candidate segment (“Single Candidate”), or determines at S714 that there is a single top score for one candidate segment of multiple candidate segments (“yes”), then at S715 to S717 the process further evaluates the candidate segment to confirm that there is sufficient confidence that the subject surveillance data point (report) is associated with the candidate segment.

At S715, the process computes a time gate and a space gate for the candidate segment based on a metadata matching analysis with the last surveillance data point added to the subject candidate segment. Generally, the process calculates time and space gates based on an expected difference in time and space between successive surveillance data points (reports) in a track segment for the subject sensor. However, in making this calculation at S715, the process may vary the calculated size of the time and/or space gates. For example, on the one hand, if the process determines that the metadata of the subject surveillance data point (report) closely matches the metadata of the last surveillance data point added to the candidate segment (i.e., the metadata matches for all significant metadata fields), then the process may calculate a relatively wide time gate and/or space gate because there will be a high level of confidence that the subject surveillance data point (report) matches the candidate segment. On the other hand, if the process determines that the metadata of the subject surveillance data point (report) does not closely match the metadata of the last surveillance data point added to the candidate segment (i.e., the metadata does not match for at least one significant metadata field), then the process may calculate a relatively narrow time gate and/or space gate because there will be a lower level of confidence that the subject surveillance data point (report) matches the candidate segment. Those skilled in the art readily will be able to identify alternative processes for determining time and space gates suitable for a desired track segmentation by sensor process and threaded track process and application.

At S716 the process determines whether a current time of the subject surveillance data point (report) is within the desired time gate calculated for the candidate segment. If the process determines that the current time of the subject surveillance data point (report) is within the calculated time gate (“yes”), then the process continues to S717.

At S717 the process determines whether a spacing of the subject surveillance data point (report) is within the desired space gate calculated for the candidate segment. If the process determines that the current surveillance data point (report) is within the calculated space gate (“yes”), then the process proceeds to S718, and the process adds the surveillance data point (report) to the candidate segment.

If at either S716 or S717 the answer is “no” (that is, the process determines that either the current time or space of the subject surveillance data point (report) is not within the respective calculated time gate or space gate), then the process proceeds to S713, the process creates a new segment including the subject surveillance data point (report), and the new segment becomes an active segment in the segment list.

It will be appreciated that, in the various above-discussed decisions and process for creating a new segment when there is no clear match (i.e., when there is either (1) no candidate segment or (2) multiple candidate segments but no single top score) or when there is a single candidate segment or top score candidate segment but a current time or spacing of the subject surveillance data point (report) is not within the calculated time gate or space gate, the track segmentation by sensor process errs on the side of creating a new track segment and not adding a subject surveillance data point (report) to an active candidate segment to which it does not clearly match. As discussed below, the overall treaded track process includes further processing that evaluates the surveillance point data at the segment level and associates (e.g., merges/reassembles/joins together) track segment pairs that are later determined to correspond to a single tracked aircraft.

FIG. 7C illustrates an “Update Segment List” subroutine for updating a list of active track segments to which a subject individual surveillance data point (report) may be assigned in the “Process Time-Step” subroutine of FIG. 7B. As discussed above, each time the track segmentation by sensor routine performs a Process Time-Step routine 5706 (see FIG. 7B), the process performs an Update Segment List subroutine S710.

At S719 the process identifies the current time for the process time-step (see, e.g., discussion at FIG. 7A, S705).

The process then determines, for each track segment in the segment list, whether the track segment is active for the current “Process Time-Step” routine (FIG. 7B).

At S720 the process determines a value of a difference between the current time and a last time at which a surveillance data point (report) was added to the subject track segment.

At S721 the process determines whether the value is greater than a threshold value. The threshold value is determined based on an expected time difference between successive surveillance track points (reports) for an item being tracked by the subject sensor. For example, the threshold value may correspond to a single or multiple of the time for a process time-step for the sensor. In an exemplary aircraft surveillance/tracking system, an expected time difference between successive surveillance track points (reports) of a radar may be the sweep time for the radar. Those skilled in the art readily will be able to determine an expected time difference suitable for a particular sensor in a desired threaded track process and application.

If at S721 the process determines that the value is greater than the threshold value (“yes”), then the process proceeds to S722, terminates the subject track segment, and removes the track segment from the active segment list.

If at S721 the process determines that the value is not greater than the threshold value (“no”), then the process proceeds to S723, and keeps the subject segment active on the segment list.

It will be appreciated that, in this manner, the “update segment list” subroutine process efficiently updates the active segment list for a current process time-step, minimizes the number of active segments on the segment list that require metadata comparison in the current process time-step, and thereby minimizes processing time and processing power required for the overall track segmentation by sensor process.

The track segmentation by sensor routine described above is exemplary only. For example, the exemplary track segmentation by sensor process, including an iterative process time-step routine, is configured to perform track segmentation by sensor for a sensor that is tracking multiple items and reporting surveillance point data reports for the multiple tracks items. For a sensor that tracks only a single item, e.g., an on-board GPS sensor in an aircraft, the sensor reports only surveillance point data for that single item (aircraft/flight), and the segmentation by sensor process does not require segmenting out track segments of surveillance data points for multiple tracked items. Those skilled in the art readily will be able to identify alternative track segmentation by sensor processes suitable for a desired threaded track process.

Outlier Detection

Outlier detection is an optional filtering process of the threaded track process that identifies a surveillance data point that has a characteristic value that is not consistent with other data points in a track segment. In an exemplary aircraft surveillance/tracking system, an exemplary outlier data point may a spike altitude value in the surveillance point data for an aircraft/flight. For example, if altitude data from an altimeter sensor for a particular aircraft/flight consistently indicates 35,000 feet over a series of successive surveillance data points in a track segment, and the process then detects that an update surveillance data point includes an altitude data point indicating 70,000 feet, the process may determine that the update surveillance data point is an outlier, e.g., based on a determination that the update data value deviates by more than a desired absolute or percentage difference from a prior value in the track segment. As shown in FIGS. 4 and 5, in an exemplary threaded track process the outlier detection process may include discarding outlier data points. In exemplary embodiments, this may include discarding the erroneous altitude value, or discarding the entire track point. Those skilled in the art readily will appreciate various alternative processes for detecting and/or discarding outliers that may be used in the threaded track process of the present application.

Outlier detection is an optional process of the track segmentation by sensor process of the present application. For example, the track segmentation by sensor process alternatively may simply separate an outlier data point as a separate track segment. The outlier data then may be effectively filtered out during synthesis and fusing processing of the threaded track process, as discussed below.

Sensor Bias and Bias Correction

Sensor bias correction is another optional filtering process of the threaded track process of the present application.

Every sensor has bias, and sensor bias changes over time. It is difficult to determine a sensor's bias in a real-time or live tracking environment, and it is particularly difficult to do so with high fidelity. However, it is reasonable to determine a sensor's bias in a post-acquisition process. Estimating a bias of a sensor with high fidelity generally requires analyzing an entire set of data generated by the sensor over a period of time. For example, a bias of a radar facility may vary due to changes in operational conditions, such as weather, clock settings, updated magnetic variances, and the like. Accordingly, estimating a bias of the radar facility at a given time generally requires analyzing an entire set of data generated by the radar facility over a period of time, e.g., over hours or days. As a result of analyzing an entire set of data output by a sensor over an appropriate period of time, it is possible to determine a bias of the sensor at any given time within the period. For example, analyzing a set of data for a radar may determine that the radar had a bias of +100 feet and − 1/10 of a degree in its azimuth at a particular range at a particular time or period of time.

When a bias of a sensor is known at a particular time or period of time, the bias of the sensor can be corrected by applying the sensor bias information to each of the corresponding surveillance data points of a track segment over the period of time. For example, as shown in the exemplary embodiments of FIGS. 4 and 5, the threaded track process may include sensor bias and bias correction based on predetermined analysis of the system's sensor(s). (See, e.g., Bias Correction S404 and Sensor Biases S404A). Exemplary equations for deriving various bias correction are presented below.

Exemplary Bias Correction Algorithms

The following algorithms provide a basis for deriving sensor biases from a set of correlated (overlapping) radars tracking multiple targets. Specifically, the following includes a set of least squares equations based on physical models of radar behavior that may be used to empirically derive radial, angular, and vertical biases for a given set of radar data at a given instance in time. Those skilled in the art readily will appreciate alternative and additional algorithms for deriving sensor biases suitable for a desired sensor and threaded track application.

### Radar Registration Correction

Δx=(ε_{r,A} sin(θ_{A})+r_{A}ε_{θ,A} cos(θ_{A}))−(ε_{r,B} sin(θ_{B})+r_{B}ε_{θ,B} cos(θ_{B})) (1)

Δy=(ε_{r,A} cos(θ_{A})−r_{A}ε_{θ,A} sin(θ_{A}))−(ε_{r,B} cos(θ_{B})−r_{B}ε_{θ,B} sin(θ_{B})) (2)

Δx,Δy Position difference between radars A and B for target
r_{A},θ_{A} Radial relative coordinates of target from radar A
r_{B},θ_{B} Radial relative coordinates of target from radar B
ε_{r,A},ε_{r,B} Radial error in radars A and B respectively
ε_{θ,A},ε_{θ,B} Angular error in radars A and B respectively

The above pair of equations can be used to provide a least squares solution to the radar registration error terms using multiple radars and multiple targets with redundant coverage areas.

Slant Range Correction

$${r}_{c} = {r}_{e} {cos}^{- 1} ( \frac{{z}_{s}^{2} + {z}_{t}^{2} - {r}_{t}^{2}}{2 {z}_{s} {z}_{t}} ) \qquad ( 3 )$$

rₑ Spherical radius of the earth
zₜ Altitude of the target
zₛ Altitude of the radar
rₜ Physical range of the target from the radar
r_{c} Corrected range (lateral) of the target from the radar

The above slant range correction provides a basic correction to compute the lateral range of a target given an external measurement of altitude. In the case of civilian radars, this altitude measurement is encoded in the transponder return and comes from the pressure altimeter of an aircraft.

Slant Range Error Propagation

$$\begin{matrix}{ɛ}_{{r}_{c}} = η \cdot {ɛ}_{{r}_{t}} + γ \cdot {ɛ}_{{z}_{a}} & ( 4 ) \\ η = \frac{{r}_{e}}{\sqrt{1 - {cos ( \frac{{r}_{t}}{{r}_{e}} )}^{2}}} \cdot ( \frac{- {r}_{t}}{{z}_{s} {z}_{t}} ) & ( 5 ) \\ γ = \frac{{r}_{e}}{\sqrt{1 - {cos ( \frac{{r}_{t}}{{r}_{e}} )}^{2}}} \cdot ( \frac{1 + ( \frac{{r}_{t}^{2} - {z}_{s}^{2}}{{z}_{t}^{2}} )}{2 {z}_{s}} ) & ( 6 )\end{matrix}$$

εᵣ_{_{c}} Error in the lateral target range
εᵣ_{ₜ} Error in the physical target range
ε_{z}_{ₐ} Error in the target altitude

The above slant range error terms can be derived using a propagation of error from the slant range correction equation. Equation 4 then provides an expansion of the radial error terms in Equations 1 and 2 to solve for the radar registration corrections.

Vertical Error Model

ε_{z}_{ₐ}=λ·(zₜ−zₛ) (7)

λ Solution parameter for the vertical error rate

The target altitude error term in equation 4 can also be expanded using a vertical error model to better fit the residuals in the least squares equations. In the above instance the vertical error is represented as a linear function of altitude from the radar source.

The sensor bias and bias correction process is optional in the threaded track process of the present application. For example, it will be appreciated that if a sensor used for generating the surveillance point data has a high level of accuracy, then analysis of sensor bias and bias correction processing may have little impact on the threaded track process. Alternatively, a sensor may not provide sufficient information to accurately determine or estimate its bias (or biases). This could occur, for example, in a mosaic tracking system that contains measurements from multiple unidentified radars. However, because sensor bias typically varies over time, and may be significant, sensor bias control typically would have a significant positive impact on the fidelity of a threaded track process. Accordingly, it will be appreciated that a threaded track process including the sensor bias and bias correction process can provide significant added value in high fidelity tracking.

Sensor Accuracy Models and Track Point Weights

Sensor accuracy models and track point weights processing is another optional filtering process of the threaded track process.

Similar to sensor bias described above, a model for sensor accuracy for a sensor type may be predetermined. In particular, a sensor accuracy model may be determined for a type of sensor based on analysis of the sensor type over time. In an exemplary aircraft surveillance/tracking system, analysis of a particular radar type, e.g., by analysis of multiple radar facilities of a same type, may be used to develop an accuracy model for that type of radar. An accuracy model for a particular radar or type of radar facility might indicate an accuracy +/−X feet and/or +/−Y degrees in azimuth over ore range of the radar, an accuracy of +/−M feet and/or +/−N degrees in azimuth over another range of the radar, and so on. An accuracy model for the radar or radar type thus may include a mapping of such accuracy over the entire range of the radar.

Sensor accuracy models may be applied to trajectory point data associated with each sensor type to determine an accuracy weighting for each surveillance track point generated by a respective sensor. In other words, a threaded track process optionally can use an accuracy model for a sensor to determine or estimate a degree of accuracy associated with the trajectory point data of each surveillance data point of a track segment for a tracked item.

A threaded track process may use track point weights to resolve differences in surveillance point data generated by different sources. For example, referring to FIGS. 6A and 6b, if an aircraft flies a trajectory that passes within the range of two radar facilities A and B, surveillance point data for a particular aircraft/flight may include surveillance point data from both radar A and radar B. Radar A and radar B may be of the same or different type. Generally, at each time in the aircraft flight, the sensor range (distance and azimuth) of radar A and radar B relative to the aircraft will be different. Based on prior analysis of the radar type for radar A and radar B, an accuracy model for each of radar A and radar B may be applied to the surveillance point data generated by radar A and radar B, and an accuracy weighting may be given to each trajectory data point of each track segment respectively associated with radar A and radar B. In exemplary embodiments, the threaded track process uses this track point weighting to resolve differences in trajectory data points of respective track segments generated by radar A and radar B for a same point in time for a same aircraft/flight.

Sensor accuracy model and track point weights processing is optional for a threaded track process of the present application. It will be appreciated that if sensors used for generating the surveillance point data have equivalent levels of accuracy across a full range of the sensors, then sensor accuracy model and point weight processing for the sensors may have little impact on the threaded track process. However, different sensors used in a surveillance/tracking system typically have different sensor accuracy models, and sensor accuracy model and track point weighting processing typically would have a significant positive impact on the fidelity of a threaded track process, especially in a boundary region where two or more sensors overlap. Accordingly, it will be appreciated that a threaded track process including a sensor accuracy and track point weights process can provide significant added value in high fidelity tracking.

Segment Sensor Data

After track segmentation by sensor processing, optionally including outlier detection, bias correction, track point weights processing, and/or other surveillance data validation processing, the surveillance point data comprises segmented sensor data that includes segmented track data and segmented flight metadata. Each track segment includes a series of points, including point track data and point metadata associated with the point track data. Ideally, point metadata does not change over the aircraft/flight time. However, in practice, it typically does. For example, in the exemplary aircraft surveillance/tracking embodiment of FIGS. 6A and 6B, certain elements of the flight metadata do not change over time, e.g. tail #, flight #, and the like. However, certain elements often do change over time, e.g. beacon codes and track numbers. As discussed herein, a threaded track process of the present application accommodates such changes.

As noted above, there may be as many as billions of individual surveillance data points and/or data elements to be processed in a threaded track process. At this stage of a threaded track process, the surveillance point data for a tracked item has been segmented into a manageable number of track segments (e.g., millions of data points per day), where the quantity of data points are assembled in larger units so as to make the computational process tractable.

Segment Association

A threaded track process of the present application associates the segmented sensor point data (track segments) for an item into a track segment group. A segment association process may associate surveillance point data for a single tracked entity across all surveillance/tracking facilities. For example, in an exemplary aircraft surveillance/tracking system of FIGS. 6A and 6B, the segment association process may associate flight surveillance point data across all radar and GPS facilities.

Associating track segments generally includes comparing each track segment with the other track segments, determining which track segments are associated with a single tracked item, e.g., a single aircraft/flight, and grouping associated track segments together for further processing. A segment association process may compare track segments using point metadata and/or point track data. Track segments having a high degree of correlation may be associated, e.g., merged or assembled, into a track segment network for further processing.

Track segment pairs in a segment group may be non-overlapping, partially overlapping, or fully overlapping. For example, referring to the exemplary aircraft surveillance/tracking system of FIGS. 6A and 6B, each of radar A and radar B reports surveillance point data for aircraft #1. In some portions of the flight path, the aircraft is only in the range of either radar A or radar B, and therefore only radar A or radar B reports surveillance point data for aircraft/flight #1 for that time. Accordingly, a track segmentation by sensor process may generate track segments for aircraft/flight #1, by radar A and radar B, that do not overlap in these portions of the flight/ranges. However, radar A and radar B both report surveillance point data for a portion of a flight in an overlapping range of radars A and B. Accordingly, a track segmentation by sensor process will generate respective track segments for radar A and radar B for this portion of the flight of aircraft/flight #1, and the track segments may fully or partially overlap one another.

A segment association process assures that any segment that is associated with a single item, e.g., an aircraft/flight, is included in a segment group for that item, and that any segment that is not associated with that single item is not included in the segment group for that item.

Exemplary Segment Association Routine

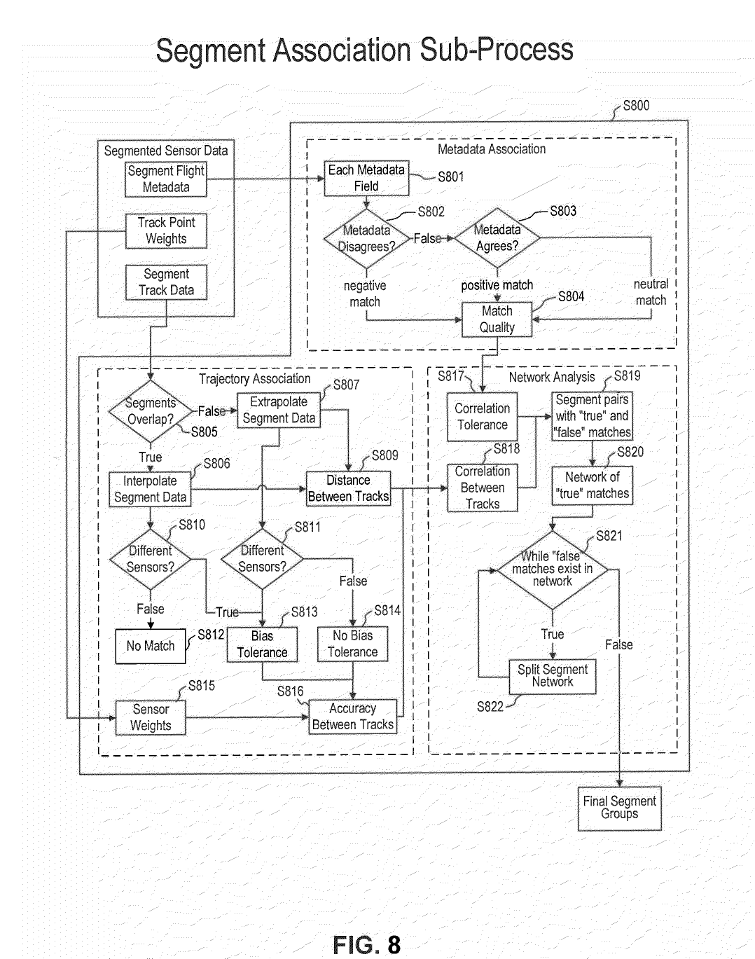

FIG. 8 illustrates an exemplary segment association routine 800 suitable for use in a threaded track process of the present application. Generally, the segment association routine 800 determines which track segments, e.g., track segments created in a track segmentation by sensor routine, if any, may be associated together in a network of track segments associated with a single tracked item.

As shown in FIG. 8, the exemplary segment association routine 800 generally starts with a segmented sensor data set that includes segmented metadata, track point weights, and segment track data. In an exemplary aircraft surveillance/tracking system, a segment association routine starts with a segmented sensor data set that includes segmented flight metadata (e.g., aircraft ID, beacon code, track number, etc.), track point weights (e.g., based on applied sensor bias and sensor model), and segment track data (e.g., latitude, longitude, altitude). Those skilled in the art readily will be able to identify segmented sensor data sets suitable for a desired threaded track system and application.

An exemplary segment association process uses two types of segment association processes or subroutines to identify candidate segments for association: Metadata Association and Trajectory Association. An exemplary segment association process generally compares track segment pairs using metadata matching and/or trajectory matching processes, and determines a degree of correlation between the pairs of track segments. Track segment pairs having a high degree of correlation may be associated (e.g., merged or assembled) into a network of track segments, or final segment groups, for further processing in the threaded track process.

An exemplary Metadata Association subroutine uses metadata that is consistent across tracking facilities for a single aircraft flight to determine whether track segments are associated with the same tracked item. In an exemplary aircraft surveillance/tracking embodiment, exemplary metadata that may be used in a metadata association process includes aircraft ID, aircraft type, beacon codes, departure location, destination location. Track number metadata typically is not used, because track numbers typically are facility specific and not constant across facilities. The inventors have found metadata in the ETMS database to be a reliable source for metadata association by matching. Those skilled in the art readily will be able to identify other metadata that is consistent across tracking facilities and may be used for metadata association.

At S801, the process considers each metadata field of a track segment in comparing the track segment with another track segment(s). In an exemplary aircraft surveillance/tracking system, the metadata association process identifies track segment pairs having matching metadata as track segment candidates that might be associated (e.g., merged) because they are associated with the same/single aircraft flight.

For each track segment pair, the process determines whether the metadata agrees, disagrees, or is indeterminate.

At S802 the process determines whether the metadata disagrees in any significant metadata field. If at S802 the process determines that the metadata disagrees in any significant metadata field (a “negative match”), then the association or match quality generally will be low and there likely can be no association of the track segments. If at S802 the process determines that the metadata does not disagree in any significant metadata field, or if there is not sufficient information to make a determination (“False”), then the process proceeds to S803.

At S803 the process determines whether the metadata agrees. If at S803 the process determines that the metadata agrees in any significant metadata field (a “positive match”), then the association or match quality generally will be high. If at S803 the process determines that there is insufficient information to make a determination, then the process determines a “neutral match” for the metadata field.

At S804 the process determines a Match Quality for each track segment pairing based on the negative match, positive match, and neutral match results. For example, the metadata association subroutine may compare seven metadata fields, and each of those metadata fields may have a negative, positive, or neutral match at varying times within the segment. If the process determines that a track segment pair includes a negative match result, then the process will determine a low match quality and the track segments likely will not be associated together. If the process determines that the track segment pair includes a positive match, then the process will determine a high match quality, and the track segments are more likely to be associated together. If the process determines a neutral match result for any significant metadata field, then the track segment pair may still be a candidate for association, because the failure to match a particular metadata field may be the result of data error and/or one track segment may be associated with a surveillance data source that does not generate metadata for the selected (significant) metadata field for the metadata association subroutine. For example, a metadata association process may use departure or destination location as a significant metadata field, and a surveillance source may not generate surveillance data that includes metadata for departure or destination location. The metadata association subroutine determines a relative match quality of a pair of track segments based on the overall matching of significant metadata fields between the two track segments.

Conceptually, a metadata association subroutine compares the metadata of each track segment with the metadata of each other track segment.

The amount of processing required for the Metadata Association subroutine may be reduced and/or minimized by using track segment grouping algorithms, e.g., using indexing, time sorting, or other techniques that group the track segments so as to compare only those track segments that can possibly match. Conceptually, metadata matching for X track segments would require X² comparisons. However, it is not necessary to compare track segments that are sufficiently different in time or space, such as track segments for aircraft flights on different days, or if a distance between end points of the track segments is too great. For example, if two track segments disagree for two significant ETMS metadata fields, then it is likely that no further match processing is required between them. Metadata matching of track segments generally is independent of time. However, in determining if metadata agrees or disagrees, the process must take into account the relative times of the track segment/reports. If two track segments overlap in time or if end points of two segments are close together, then the metadata association process makes further considerations. Those skilled in the art readily will be able to identify and apply various grouping algorithms suitable for minimizing the number of required track segment comparisons for a particular surveillance/tracking application.

The exemplary segment association routine also includes a Trajectory Association subroutine for identifying candidate track segments for association.

At S805, track segments are compared with one another to determine if they overlap in time (“true”) or if there is a gap in time between the two segments (“false”). At S805 the process determines whether two track segments overlap in time. If at S805 the process determines that two track segments being compared overlap in time (“true”), then at S806 the process interpolates segment data for the overlapping portion of the first track segment and the second track segment. For example, if the data source is a radar, then the interpolation generally will scale in accordance with the update rate of a radar, i.e., in the order of seconds. If at S805 the process determines that the two track segments being compared do not overlap in time but are close in time (“false”), i.e., there is a short time gap between end points of the two track segments, then at S807 the process extrapolates from one track segment across the gap to the other track segment, and vice versa. The extrapolation process indicates where a tracked item would have been if a track segment had continued across the gap. In this regard, it will be appreciated that extrapolated data points of one track segment may not be in sync with the data points of the other track segment.

At S809, based on the two track segments and either the extrapolation data or the interpolation data, the process determines, at a segment level, a distance between the tracks of the first and second track segments. That is, the process determines how close the two track segments are relative to one another (e.g., laterally, vertically). The distance function could also include correlation between other factors such as heading or climb rate. The distance function will also have an averaging function to create a single distance metric based on the entire segment overlap, which farther may be based on track point weights.

Prior to determining whether to associate two segments together, the process determines how far apart the two segments would be expected to be if they were from the same track (or tracked item). If two sensors have high accuracy, then two candidate segments generated by the two sensors for the same track would be expected to have high correspondence. If one sensor has a low accuracy, then two candidate segments including a candidate segment from that sensor may be expected to have a lower correspondence. An exemplary trajectory association subroutine uses the track point weights of the track segments to assign a tolerance level to each comparison to determine a correlation value between two candidate track segments.

At S810 and S811, the process determines whether two segments that overlap or have end points that are close together correspond to the same sensor. At S810 the process determines whether two track segments that overlap in time, and that have been subjected to interpolation at S806, were acquired from different sensors. At S811, the process determines whether two segments that have end points that are close together, and that have been subject to extrapolation at S807, were acquired from different sensors.

If at S810 the process determines that the two track segments are not from different sensors (“False”), i.e., the track segments were acquired from the same sensor, then at S812 the process determines that there is no match, because the two track segments would be expected to have complete correlation and no overlap.

If at S810 the process determines that the two track segments were acquired from different sensors (“True”), then at S813, the process determines a bias tolerance expected between the two track segments. It will be appreciated that this tolerance allows for any possible mismatch between the registrations of different sensors.

If at S811 the process determines that the track segments are from different sensors (“True”), then at S813 the process determines a bias tolerance expected between the two track segments based on the type of sensor or source of surveillance track data. The bias tolerance may be determined based on predetermined tolerance models for the sensors, where the predetermined tolerance models may be determined in a manner similar to the predetermined accuracy models in the track segmentation by sensor process.

If at S811 the process determines that the two track segments are not from different sensors (“False”), i.e., that the track segments are from the same sensor, then at S814 the process determines to set no bias tolerance between the track segments. In this case, the process determines that two segments that present from the same sensor and having a gap between end points of the track segments may correspond to a single trajectory, e.g., a single aircraft/flight, only if the track segments have a high correspondence among point track data. For example, if the process determines a gap between the end points of the track segments is a result of the track segmentation by sensor process, e.g., due to a sensor error, null reading, or the like, then the process determines to set no bias tolerance for the track segment pair. It will be appreciated that these two segments may still be associated together if the track point data satisfies the no bias tolerance requirement.

At S815 the process determines sensor weights for the track segments based on track point weights for the track segments, and at S816 the process determines a level of accuracy between two candidate track segments based on the sensor weights of the track segments, and the bias tolerance, if any. For example, for a radar in an aircraft surveillance/tracking system, based on the sensor weights and the bias tolerance the radar may be expected to have an accuracy within +/−1000 feet.

Accordingly, for each pair of track segments, the trajectory association routine determines both a measured distance between the track segments (S809) and an expected accuracy measurement between the pair of track segments (S816).

The segment association routine further includes a Network Analysis subroutine that analyzes comparison result information from the Metadata Association and Trajectory Association subroutines, and associates track segments into final segment groups based on a correlation result of the analysis. In the following exemplary process, network analysis is illustrated using an exemplary binary matching process. Those skilled in the art readily will appreciate that other suitable matching processes may be used. For example, in one alternative embodiment, a fuzzy logic matching processing may be used.

In the exemplary embodiment of FIG. 8, at S817 the process determines a correlation tolerance between a pair of track segments based on the match quality determined at S804. The correlation tolerance is a value determined based on the match quality between two track segments determined at S804. Typically, higher match qualities (from positive matches) would result in a lower correlation tolerance, whereas lower match qualities (from negative matches) would result in a high correlation tolerance.

At S818 the process determines a correlation value between a pair of track segments based on the calculated distance between the track segments determined at S809 and the calculated accuracy value between the pair of track segments determined at S816. In one implementation, this correlation may be a simple ratio of the distance between tracks at S809 to the accuracy between tracks at S816. The correlation may be based on higher order relations between the two inputs but is generally lower when the distance is high relative to the accuracy.

FIG. 8 illustrates at S819 to S822 an exemplary embodiment of a process that generally performs an algorithm for identifying communities in complex networks. Those skilled in the art will recognize alternative algorithms for performing this function.

At S819 the process identifies track segment pairs with “true” and “false” matches based on the correlation tolerance and correlation values calculated for the track segment pairs. A “true” match comes when the correlation between tracks at S818 is within the correlation tolerance at S817. High correlation tolerances in S817 often allow a correlation where the distance between tracks exceeds the accuracy between tracks. This higher tolerance would be due to higher agreement between the metadata matching. Conversely, a lower correlation tolerance, due to disagreement in the metadata matching, may be more restrictive in the correlation at S818 and require a distance between tracks well below the accuracy of the tracks. It will be appreciated that other machine learning approaches may be applied that do not require a binary association or matching between segments.

At S820 the process determines a network of “true” matches. In an exemplary embodiment, this network is built from all segment pairs that have a “true” connection, regardless of any “false” matches. In this instance, if the association/matches between track segments A, B, and C produce true matches between (A,B) and (B,C), but a false match between (A,C), then the network would consist of segments (A,B,C).

At S821 the process determines whether the network of “true” matches includes any “false” match. If at S821 the process determines that the network does not include any “false” match, then the process presents the network as a final segment group.

If at S821 the process determines that the network of “true” matches includes a “false” match, then the process proceeds to S822.

At S822, the process splits the network of track segments based on the “false” match, and the process returns to S821. For example, assume the track segment network includes track segments A, B, and C as described above, where analysis of track segment A and track segment B indicates a “true” match (i.e., analysis indicates that track segment A and track segment B are the same trajectory), and where analysis of track segment B and track segment C indicates a “true” match, but where analysis of track segment A and track segment C indicates a “false” match (i.e., track segment A and track segment C definitely are not in the same trajectory for a single tracked item). At S822, the process analyzes the “true” and “false” matches among track segments A, B, and C, splits the network of track segments at track segment B, and determines whether track segment B should be included with either or none of track segment A or track segment C. For example, in an aircraft tracking system, track segment A may definitely correspond to Delta flight #100, track segment C may definitely correspond to American flight #100, and track segment B (no flight ID) may include data matching, both to track segment A and track segment C. At S822, the process splits the track segment network at track segment B and assigns track segment B either to track segment A, track segment C, or neither. Because this situation generally only occurs due to corrupted data, e.g., in track segment B, and corrupted data typically is identified and discarded in a track segmentation by sensor process, this situation rarely occurs (e.g., less than 1% of the time). However, because of the statistical nature of the matching, it is possible that this may also occur (although infrequently) when some segments have been incorrectly matched due to errors in trajectory. This splitting process can break weaker matches that were determined at S819 due to additional information provided by the network of segments (whereas matches at S819 were based only on segment to segment comparisons).

In this manner, the segment association routine presents a final segment group composed of a network of track segments associated with a single tracked item, e.g., a single aircraft/flight.

It will be appreciated that in the various above-discussed routines and processes of the threaded track process, processing of the surveillance point data generally is performed on a per segment basis. In the following multi-processor synthesis and fusion of track segments process, processing is performed across track segments of a segment group associated with a single tracked item, e.g., across track segments of a segment group associated with a single aircraft/flight.

Multi-Sensor Synthesis and Fusion

Multi-sensor synthesis and fusion processing of the threaded track process operates on track segments associated with a single tracked item, including filtering and fusing track segments together to provide a single synthetic trajectory, or threaded track.

Multi-sensor synthesis and fusion processing includes filtering or smoothing of track segments for a single tracked item in space and time. For a portion of a trajectory where there is only one tracking sensor or source of surveillance track data, a threaded track process includes filtering the surveillance track data to provide the best available trajectory data. For a portion of the trajectory where there are multiple tracking sensors or sources of surveillance track data, a threaded track process includes filtering the surveillance track data of respective sensors and fusing the track segments for the sensors, e.g., based on a weighting of the track segments, to provide the best available trajectory data.

In the exemplary embodiments of FIGS. 4 and 5, the multi-sensor synthesis and fusion process includes filtering across track segments, e.g., cross track filtering, along track filtering, and vertical track filtering of track segments/segment groups, to obtain a single synthetic trajectory (an exemplary cross track model is presented below; those skilled in the art readily will appreciate other models suitable for these filtering processes). Generally, filtering may be performed as a parameterized or non-parameterized function. For example, in an embodiment cross track filtering may be performed as a non-parameterized function by applying a straight line filter and a variable radius filter to latitude/longitude surveillance point data. Along track filtering may be performed as a parameterized function by obtaining speed information from the track point data and filtering out along track error in the surveillance track data as a function of time, e.g., timing error in the surveillance track data. And vertical track filtering may be performed using a parameterized function by removing vertical track error in the surveillance track data as a function of distance along the track, e.g., removing altitude error in the surveillance track data. The lateral trajectory is a data set that includes final (filtered or smoothed) latitude and longitude data points, but also includes additional information such as heading, air speed, acceleration, and the like. Combining a filtered lateral track trajectory (resulting from the cross track filtering and along track filtering) together with a vertical track trajectory (resulting from vertical track filtering of the lateral track trajectory) results in a synthetic trajectory for the surveillance track data of a single tracked item, e.g., a single aircraft/flight. The synthetic trajectory/track data and associated flight metadata form a synthetic threaded track data set for the tracked item, e.g. an aircraft/flight. The threaded track provides a single set of high fidelity trajectory point data for the tracked item, e.g., a single aircraft/flight.

Exemplary Cross Track Model

The following algorithms provide a basis for cross track filtering or “smoothing.” Specifically, the following is one example of a set of models that may be used in a multi-model least squares filtering solution given an input set of lateral trajectory measurements. The result is a mixed-model solution that will provide the location, direction, and curvature for a given set of input data. This process is iterated over blocks of trajectory measurements to build up a flight path over time.

Straight Least Squares Model

$$\begin{matrix}ax + by = 1 & ( 8 ) \\ E = {\sum }_{i} ( {ax}_{i} + {by}_{i} - 1 ) & ( 9 )\end{matrix}$$

(x,y) Local orthogonal coordinates
(xᵢ,yᵢ) Data samples in local coordinates
(A,B) Linear solution parameters
E Least squares error for straight model

The above straight least squares model provides a least squares solution to the straight path of aircraft flight given a set of lateral trajectory measurements.

Turn Least Squares Model

$$\begin{matrix}{( x - {x}_{c} )}^{2} + {( y - {y}_{c} )}^{2} = {r}^{2} & ( 10 ) \\ E = {\sum }_{i} ( {( {x}_{i} - {x}_{c} )}^{2} + {( {y}_{i} - {y}_{c} )}^{2} - {r}^{2} ) & ( 11 )\end{matrix}$$

(x,y) Local orthogonal coordinates
(xᵢ,yᵢ) Data samples in local coordinates
(x_{c},y_{c}) Turn center solution parameters
r_{c} Turn radius solution parameter
E Least squares error for turn model

The above least squares turn model provides a least squares solution to a constant radius turn path of aircraft flight given a set of lateral trajectory measurements.

Mixed Model Solution

$${\vec{x}}_{i} = \frac{{S}_{turn} {\vec{x}}_{turn} + {S}_{straight} {\vec{x}}_{straight}}{{S}_{turn} + {S}_{straight}} \qquad ( 12 )$$

\vec{x}ₜᵤᵣₙ Position solution provided by equation 3
\vec{x}_{straight} Position solution provided by equation 1

Those skilled in the art readily will appreciate additional and alternative models for across track filtering suitable for a desired treaded track process and application.

The order of the filtering processes is not limited to the order illustrated in exemplary embodiments of FIGS. 4 and 5. For example, the order of the cross track, along track, and vertical track filtering processes may be changed. However, the inventors have found that the order of cross track filtering, along track filtering, and vertical track filtering illustrated in the exemplary embodiments of FIGS. 4 and 5 is preferred for processing efficiency and high fidelity. All measurements in time and space involve error in multiple dimensions. Accordingly, filtering of error in track segments of surveillance point data in any dimension necessarily affects the fidelity of measurement data in other dimensions. The inventors have found that the illustrated order of across track filtering processes provides efficient processing with introduction of minimum error.

In an exemplary embodiment, the filtering process of the threaded track process of the present application is generally analogous to a Kalman filter technique or process as typically used in known live tracking systems. As used in known live tracking systems, a Kalman filter process in essence is a real-time process that receives update data and estimates a current trajectory based on a weighting of past trajectory point data and the update point data. In contrast, a threaded track process in essence is a post-acquisition process. In a threaded track process of the present application, the filtering process uses both “past” surveillance point data and “future” surveillance point data to estimate a “current” surveillance data point. In this regard, in a treaded track process of the present application “current” refers to a particular time selected within a post-acquisition data set. In this manner, because the surveillance point data includes information from both before and after the “current” trajectory data point, i.e., the process knows where the tracked item came from and to where it goes, the filtering process of a threaded track process of the present application can estimate a “current” trajectory data point with significantly higher fidelity because the threaded track process estimates the current trajectory data point based on a weighting of both “past” and “future” trajectory point data. Also, it will be appreciated that as the amount of surveillance data available in the data set before and after the “current” time increases, the fidelity of the resulting filtered or “smoothed” data set generally also increases.

It will be appreciated that a threaded track process of the present application, including track segmentation by sensor, association of track segments in a segment group, and multi-sensor synthesis and fusion of track segments in the segment group, in one aspect provides a significant improvement over conventional tracking systems and databases in that it enables collection and association of surveillance point data from multiple sources that are operated independently and not in registration or sync with one another.

Exemplary Filtering Routine

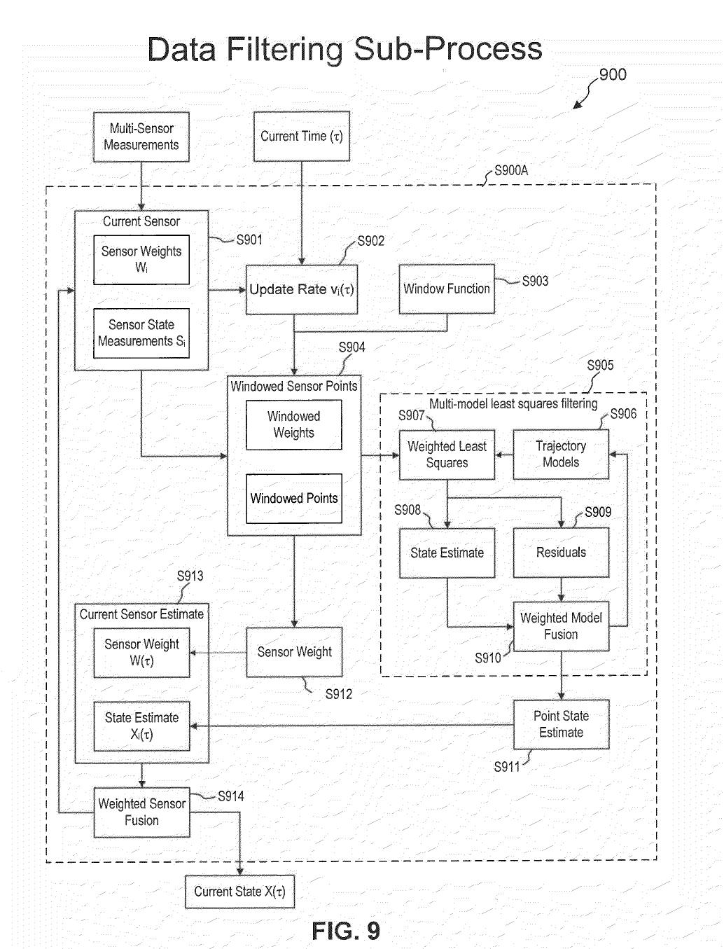

FIG. 9 graphically illustrates an exemplary filtering routine or process 900 that may be used with a threaded track process of the present application. The filtering routine 900 illustrated in FIG. 9 may be used for each of the cross track, along track, and vertical track filtering processes illustrated in the exemplary threaded track embodiments of FIGS. 4 and 5.

As illustrated in FIG. 9, the filtering process routine 900 of the present application operates on multi-sensor measurements in track segments. That is, in the exemplary embodiments of FIGS. 4 and 5, the multi-sensor measurements may be presented in a network of associated segment groups, as discussed above.

Generally, as indicated by the dashed line at S900A, the filtering process cycles through all sensors or data sources for each given “current time (t).” That is, for a current time t within a period of a trajectory, the process determines a current state X(t) for the tracked item. In an exemplary aircraft tracking system, a current state X(t) for a cross track filtering process defines a single synthetic track point at time (t), e.g., latitude and longitude, based on fusion of sensor state measurements Sᵢ for all sensors actively tracking the aircraft/flight at time (t).

At S901, the process identifies a Current Sensor. Current sensor information used in the process includes Sensor Weights Wᵢ and Sensor State Measurements Sᵢ. Sensor weights Wᵢ may correspond, for example, to sensor accuracy weights for the sensor (see, e.g., discussion at FIG. 4, S405 above). State measurements Sᵢ include all surveillance data points for the current sensor.

At S902, for each given current sensor and current time (t), the process identifies a uniquely defined update rate “v(t)” for the sensor. For example, in an exemplary aircraft tracking system, a radar may have an update rate v(t)=4 seconds, corresponding to a sweep time of the radar. The process uses the update rate v(t) for determining bandwidths of the filters. In general, a filter bandwidth will scale with the update rate so that an equivalent signal density is applied to each measurement. As larger bandwidths will also filter out higher order signals in the data, they are therefore typically weighted lower in the presence of higher update sources.

At S903, the process defines a window function for the current sensor and update rate. The window function generally may be any window function known now or in the future and is typically selected for its favorable frequency response characteristics. In an exemplary embodiment, the window function is a Gaussian function (bell curve function). The filtering process generally uses the window function to limit the number of sensor state measurements Sᵢ used for determining a point state estimate and current state X(t) to those sensor state measurements Sᵢ that are local to the current state X(t), and therefore more reliable. For example, in an aircraft surveillance/tracking embodiment, the process may window twenty (20) radar state measurements for determining a point state estimate at the middle of the windowed sensor points, and the 20 windowed radar state measurements will be weighted based on a Gaussian bell curve function, according to a windowed filtering technique. Those skilled in the art readily will be able to identify a window function suitable to a desired tracking application and sensor.

At S904 the process applies the window function and the update rate v(t) to the sensor state measurements Sᵢ to determine Windowed Sensor Points. It will be appreciated that the windowed sensor points information includes Windowed Points and associated Windowed Weights. The windowed weights are defined as the product of the sensor weights within the window's extent and the window function and the windowed points as the selection of points within the window's extent.

At S905 (indicated by a dashed line), the process performs an averaging function on the windowed sensor points to determine a Point State Estimate for time (t). In an exemplary embodiment, as illustrated in FIG. 9, the process may apply multi-model least squares filtering to the windowed sensor points. It will be appreciated that, in an embodiment, this averaging function could also apply higher order or non-linear filtering models to determine the state estimate.

At S906 the process identifies one or more predetermined Trajectory Models. A trajectory model may be predetermined based on an expected behavior of the tracked item. For example, in an exemplary aircraft surveillance/tracking embodiment, for cross track filtering the expected behavior of an aircraft (trajectory model) could be a straight line model, a constant curvature (turning) model, or a variable curvature (higher order, variable radius turning) model. (See exemplary cross track model above). Similarly, for along track filtering, an expected behavior of an aircraft (trajectory model) could be a constant velocity model, a constant acceleration model, or a variable acceleration (higher order) model. Likewise, for vertical track filtering, an expected behavior of the aircraft (trajectory model) could be a linear ascent/descent trajectory model, or a higher order ascent/descent trajectory model. The trajectory models may be predetermined based on characteristics of the tracked item. In an exemplary aircraft surveillance/tracking system, the trajectory models may be predetermined based on design and flight characteristics of the aircraft. For example, aircraft that fly a constant climb rate (as is common at higher altitudes) might select a linear ascent/descent rate model, whereas aircraft that fly a constant climb gradient (as is common at lower altitudes) might select a linear ascent/descent gradient model. Generally, higher order trajectory models are not used because such higher order models are more sensitive to noise, and are not essential to civil aviation aircraft due to their more basic and predictable maneuvering. In an exemplary embodiment, as illustrated in FIG. 9, each across-tracks filtering process may include application of two different trajectory models to the weighted windowed data to determine a best point state estimate of a synthetic trajectory for the threaded track. Those skilled in the art readily will be able to select a trajectory model(s) and algorithm(s) suitable for a desired threaded track filtering process.

At S907 the process performs least squares filtering of the windowed sensor points based on a selected trajectory model(s). As noted above, in an exemplary embodiment, the process performs least squares filtering for two different trajectory models. For cross track filtering, the process uses a straight trajectory model and a constant curvature (tun) model (e.g., see above). For along track filtering, the process uses a constant velocity model and a constant acceleration model. For vertical track filtering, the process uses a linear ascent/descent model.

The least squares filtering results in a State Estimate S908 and Residuals S909 for each trajectory model. A State Estimate is determined as the least squares fit to each trajectory model, with the residuals as the difference between the fitted model and the windowed points.

At S910 the process performs Weighted Model Fusion based on the state estimate S908 and residuals S909 for each trajectory model. Generally, based on the state estimates and residuals for the two trajectory models, the process determines how closely each trajectory model fits the windowed sensor points, and weights the respective state estimate S908 for each trajectory model. For example, if an aircraft is travelling in a straight line, then based on analysis of the windowed sensor points applying a straight line trajectory model and a constant curvature (turning) trajectory model, respectively, the process will determine a state estimate for the straight line trajectory model having a higher weight than a state estimate for the constant curvature (turning) trajectory model. In one embodiment, the weighting between the models may be a binary switch to select a model state or an averaging function to define a mixed model. The model fusion is generally based on each model's residuals, where lower residuals result in a higher contribution of the given model.

At S911 the process presents a Point State Estimate for current time (t) based on a result of the multi-model least squares filtering. This is the synthetic or composite point state estimate for the given segment over all its trajectory models.

At S912 the process determines a Sensor Weight associated with the Point State Estimate at S911. The sensor weight is determined by averaging the windowed weights for the windowed sensor points at S904. In an alternative embodiment (not shown), the sensor weight may also include contributions from the residuals at S909. It will be appreciated that, in practice, sensor weighting generally will change slowly. For example, in an aircraft surveillance/tracking system, a sensor weight for a radar will change slowly as the aircraft passes through the range of the radar because the accuracy of the radar changes slowly over its range.

At S913 the process defines a Current Sensor Estimate including a Sensor Weight W(t) and a State Estimate Xᵢ(t) for a single sensor. The sensor weight W(t) corresponds to the sensor weight at S912. The state estimate Xᵢ(t) corresponds to the point state estimate presented at S911.

The above filtering process is repeated for all sensors providing surveillance data measurements at the selected current time (t).

At S914 the process fuses the current sensor estimate for all sensors at time (t) and presents a Current State X(t). That is, for each sensor, the process has performed filtering of the surveillance point data from the sensor at the current time (t). In an embodiment, the weighted sensor fusion is a weighted average. It will be appreciated that in all realistic cases there will be a difference in registration and bias between sensors. Accordingly, the process performs filtering and weighting of each sensor's track, followed by fusing the weighted tack points together. It will be appreciated that this process essentially removes the effect of sampling rate error between sensors, e.g., between two radar facilities that have different registration and/or that have sampling or update rates that are different or out of sync. This prevents a “sawtoothing” effect in the fusion, where the fused trajectory would contain higher frequency components due to different sensors with a slight bias.

In the exemplary filtering routine of FIG. 9, it will be appreciated that the “Current Time (t)” may be arbitrarily selected, and further that the sampling rate for the current time (t) may be arbitrarily selected, allowing interpolation anywhere along the trajectory. However, it will be appreciated that the sampling rate has an effective lower limit on the order of the highest update rate sensor at a given time (t). That is, the rate of data points in the synthetic trajectory is variable, based on the sensor inputs. For a given period of time in the trajectory, e.g., for a period in which multiple sensors provide surveillance data input (e.g., input from two radar facilities), the rate of data points in the synthetic trajectory is limited by the slowest update rate of the sensors.

Near Real-Time Tracking

In another aspect, a threaded track process of the present application may be used to provide a near real-time tracking process. In this aspect, a threaded track process runs with a time delay equal to at least the slowest sensor update rate in the system. In this aspect, the threaded tack process treats a most recent update surveillance point data as “future” data, and treats the immediately prior received surveillance point data as the “current” data. It will be appreciated that by treating the most recent update surveillance point data as “future” data, the threaded track process of the present application can provide higher fidelity filtering (“smoothing”) of the immediately prior received “current” surveillance point data based on both “prior” surveillance point data and “future” surveillance point data. That is, the threaded track process may provide higher fidelity near real-time tracking of the “current” surveillance data, with a time delay equal to the sensor update rate. The time delay may be in the order of seconds to minutes, depending on the slowest update rate for the plurality of sensors in the surveillance/tracking system. Further, it will be appreciated that the fidelity of the near real-time tracking using a threaded track process may increase by increasing the time delay, i.e., by increasing the number of surveillance data points treated as “future” data point. It further will be appreciated that the speed of the near real-time tracking system may vary depending of the processing speed of the system, the number of input data sensors, and the amount of surveillance point data. This near real-time tracking process may have particular utility in tracking applications that do not require immediate track location, such as flow management across the national airspace system. Those skilled in the art readily will be able to identify suitable tracking applications for near real-time tracking methods and systems implementing a threaded track process of the present application.

Exemplary Processing Device

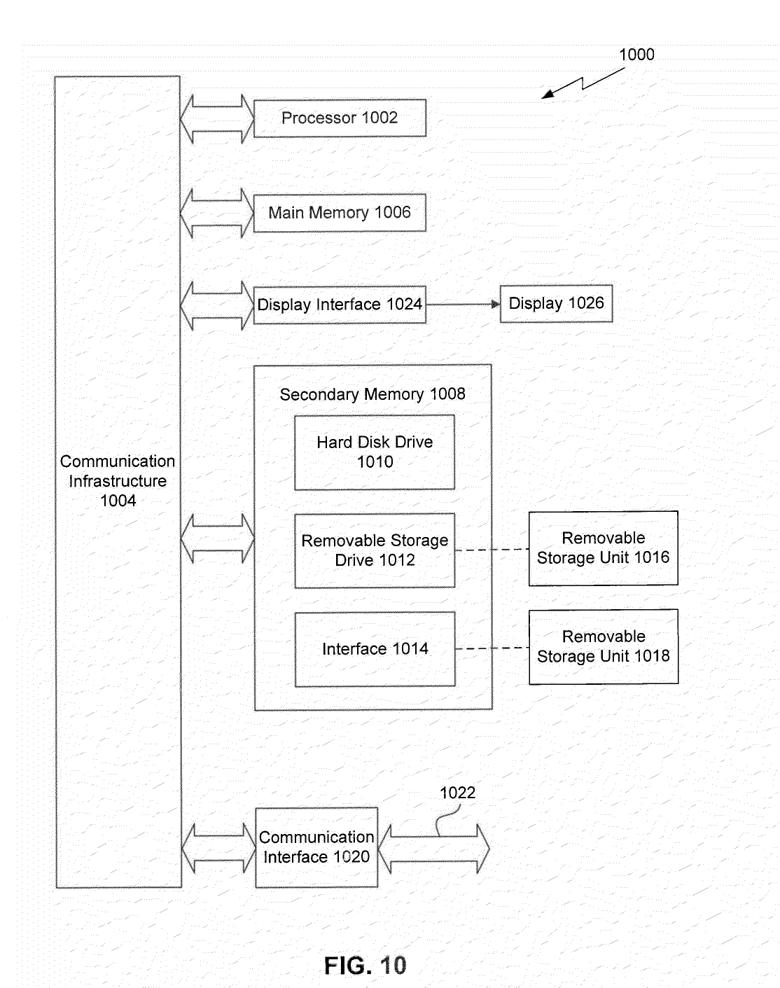

FIG. 10 is a high-level block diagram of a computer system 1000 that may be used to implement a threaded track process in accordance with the present application. As shown in FIG. 10, computer system 1000 includes a processor 1002 for executing software routines. Although only a single processor is shown for the sake of clarity, computer system 1000 may also comprise a multi-processor system. Processor 1002 is connected to a communication infrastructure 1004 for communication with other components of computer system 1000. Communication infrastructure 1004 may comprise, for example, a communications bus, cross-bar, or network. In a case where the data set is extremely large, a threaded track process of the present application may be implemented in a distributed or parallel cluster system.

Computer system 1000 further includes a main memory 1006, such as a random access memory (RAM), and a secondary memory 1008. Secondary memory 1008 may include, for example, a hard disk drive 1010 and/or a removable storage drive 1012, which may comprise a floppy disk drive, a magnetic tape drive, an optical disk drive, or the like. Removable storage drive 1012 reads from and/or writes to a removable storage unit 1016 in a well known manner. Removable storage unit 1016 may comprise a floppy disk, magnetic tape, optical disk, or the like, which is read by and written to by removable storage drive 1012. As will be appreciated by persons skilled in the art, removable storage unit 1016 includes a computer-readable storage medium having stored therein computer software and/or data.

In alternative embodiments, secondary memory 1008 may include other similar means for allowing computer programs or other instructions to be loaded into computer system 1000. Such means can include, for example, a removable storage unit 1018 and an interface 1014. Examples of a removable storage unit 1018 and interface 1014 include a program cartridge and cartridge interface (such as that found in video game console devices), a removable memory chip (such as an EPROM, or PROM) and associated socket, and other removable storage units 1018 and interfaces 1014 which allow software and data to be transferred from removable storage unit 1018 to computer system 1000.

Computer system 1000 further includes a display interface 1024 that forwards graphics, text, and other data from the communication infrastructure 1004 or from a frame buffer (not shown) for display to a user on a display unit 1026.

Computer system 1000 also includes a communication interface 1020.

Communication interface 1020 allows software and data to be transferred between computer system 1000 and external devices via a communication path 1022. Communication interface 1020 may comprise an HPNA interface for communicating over an HPNA network, an Ethernet interface for communicating over an Ethernet, or a USB interface for communicating over a USB. However, these examples are not limiting, and any communication interface 1020 and any suitable communication path 1022 may be used to transfer data between computer system 1000 and external devices.

As used herein, the term “computer program product” includes a computer-readable or computer useable medium, and may refer, in part, to removable storage unit 1016, removable storage unit 1018, a hard disk installed in hard disk drive 1010, or a carrier wave carrying software over communication path 1022 (wireless link or cable) to communication interface 1020. A computer-readable medium can include magnetic media, optical media, or other tangible or non-transient recordable media. A computer useable medium can include media that transmits a carrier wave or other signal. These computer program products are means for providing software to computer system 1000.

Computer programs (also called computer control logic) are stored in main memory 1006 and/or secondary memory 1008, and are executed by the processor 1002. Computer programs can also be received via communications interface 1020. In an embodiment of the present invention, the threaded track process is a computer program executed by processor 1002 of computer system 1000.

The computer system 1000 may comprise a personal computer operating under the Microsoft WINDOWS operating system. However, this example is not limiting. As will be appreciated by persons skilled in the relevant art(s) from the teachings provided herein, a wide variety of other computer systems 1000 may be utilized to practice the present invention.

### CONCLUSION

While various embodiments of a threaded track process of the present application have been described above, it should be understood that the embodiments have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. A method for determining a trajectory of an item, comprising:
segmenting, by sensor, into track segments for the item, surveillance point data of plural sensors for tracking the item, wherein each track segment includes time serial surveillance point data for the item that is associated with a single sensor of the plural sensors;
associating the track segments for the item in a segment group; and
fusing the track segments in the segment group into a synthetic trajectory for the item.

2. The method of claim 1, wherein at least one sensor of the plural sensors is unrelated to at least one other sensor of the plural sensors.

3. The method of claim 1, wherein each sensor of the plural sensors is for tracking the item over at least a portion of the trajectory of the item.

4. The method of claim 1, further comprising parsing the surveillance point data into metadata for the item and point track data for the item.

5. The method of claim 1, wherein the segmenting comprises validating the surveillance point data.

6. The method of claim 5, wherein the validating comprises detecting undesired data in the surveillance point data.

7. The method of claim 6, wherein the detecting undesired data comprises detecting at least one of corrupted data, coasted data, and outlier track point data in the surveillance point data.

8. The method of claim 6, wherein the validating comprises discarding the undesired data in the surveillance point data.

9. The method of claim 5, wherein the validating comprises detecting an outlier track segment.

10. The method of claim 9, wherein the validating comprises discarding the outlier track segment.

11. The method of claim 5, wherein the validating comprises correcting a sensor-based bias of the surveillance point data.

12. The method of claim 11, wherein the sensor-based bias is a predetermined, sensor-specific bias.

13. The method of claim 5, wherein the validating comprises assigning track point weights to the surveillance point data.

14. The method of claim 13, wherein the assigning track point weights to the surveillance point data comprises applying a sensor accuracy model for the sensor that generated the surveillance point data.

15. A method for determining a trajectory of an item, comprising:
receiving track segments for the item, wherein each track segment includes time serial surveillance point data for the item that is associated with a single sensor of plural sensors for tracking the item; and
associating the track segments for the item in a segment group.

16. The method of claim 15, wherein at least one sensor of the plural sensors is unrelated to at least one other sensor of the plural sensors.

17. The method of claim 15, wherein each sensor of the plural sensors is for tracking the item over at least a portion of the trajectory of the item.

18. The method of claim 15, wherein the associating of the track segments includes determining an association between a pair of track segments based on a correlation characteristic, and forming a network of track segments for the item based on the determined association.

19. The method of claim 15, wherein the associating of the track segments comprises determining whether a track segment includes sufficient data for reliably associating the track segment with the segment group.

20. The method of claim 19, wherein the determining comprises at least one of determining whether the track segment includes less than a threshold number of track data points and determining whether the track segment includes metadata sufficient for metadata association.

21. The method of claim 15, wherein the associating of the track segments comprises associating metadata of the track segments for the item.

22. The method of claim 21, wherein the associating of metadata of the track segments comprises matching at least one element of metadata in the surveillance point data for the item.

23. The method of claim 15, wherein the associating of the track segments comprises associating trajectory data of the track segments for the item.

24. The method of claim 23, wherein the associating of trajectory data comprises matching at least one component of metadata in the surveillance point data for the item.

25. The method of claim 23, wherein the associating trajectory data comprises extrapolating segment data for non-overlapping track segments for the item.

26. The method of claim 23, wherein the associating trajectory data comprises interpolating segment data for overlapping track segments for the item.

27. A method for determining a trajectory of an item, comprising:
receiving track segments for the item, the track segments associated in a segment group, wherein each track segment includes time serial surveillance point data for the item that is associated with a single sensor of plural sensors for tracking the item; and
fusing the track segments in the segment group into a synthetic trajectory for the item.

28. The method of claim 27, wherein the fusing comprises filtering across track segments for the item.

29. The method of claim 28, wherein the filtering across track segments comprises at least one of cross track filtering, along track filtering, and vertical track filtering.

30. The method of claim 28, wherein the filtering across track segments comprises windowing track points of the track segments.

31. The method of claim 30, wherein the filtering across track segments comprises weighted least squares filtering of the windowed track points.

32. The method of claim 31, wherein the filtering across track segments comprises applying a trajectory model to the weighted least squares filtering of windowed track points.

33. The method of claim 32, wherein the filtering across track segments comprises applying at least one trajectory model selected from a first order function, a second order function, and a higher order function.

34. The method of claim 32, wherein the filtering across track segments comprises cross-track filtering, and the cross-track filtering comprises applying at least one trajectory model selected from a straight trajectory model, a constant curvature trajectory model, and a variable curvature trajectory model.

35. The method of claim 32, wherein the filtering across track segments comprises along-track filtering, and wherein the along-track filtering comprises applying at least one trajectory model selected from a constant velocity model, a constant acceleration model, and a higher-order variable-acceleration model.

36. The method of claim 32, wherein the filtering across track segments comprises vertical-track filtering, and wherein the vertical-track filtering comprises applying at least one trajectory model selected from a linear climb gradient trajectory model, a linear climb rate trajectory model, and a higher order ascent/descent trajectory model.
